(19) United States
(12) Patent Application Publication
(10) Pub. No.: US 2026/0120534 A1
(43) Pub. Date: Apr. 30, 2026

(54) METHODS AND SYSTEMS FOR DETECTING A DISCREPANCY BETWEEN ACCESS RULES OF ACCESS CONTROL EQUIPMENT AND AN ACCESS POLICY

(71) Applicant: GENETEC INC., Saint-Laurent (CA)

(72) Inventor: Pierre RACZ, Montreal (CA)

(21) Appl. No.: 19/372,001

(22) Filed: Oct. 28, 2025

Related U.S. Application Data
(60) Provisional application No. 63/713,630, filed on Oct. 30, 2024.

(51) Int. Cl. G07C 9/20

(52) U.S. Cl. CPC G07C 9/20

(57) ABSTRACT

Methods, systems, and computer-readable media are described herein for receiving access events from access control equipment controlling physical access to a secured premises, comparing each access event to an access policy, detecting that a particular access event violates a clause of the access policy, and generating a compensatory action item for the particular access event that violates the access policy. The access control equipment includes a door controller and one or more readers in communication with the door controller. The door controller is configured to receive requests from the one or more readers, to control access to the secured premises based on access rules for the secured premises, and to generate the access events based on the requests from the one or more readers.

### CROSS-REFERENCE TO RELATED APPLICATIONS

This application claims priority under 35 U.S.C. 119(e) of U.S. Provisional patent application bearing Ser. No. 63/713,630, filed on Oct. 30, 2024, the contents of which are hereby incorporated by reference.

### TECHNICAL FIELD

The present disclosure relates generally to physical access control with access control equipment, and, more particularly, to methods and systems for detecting that an access event generated from access control equipment based on access rules violates an access policy and generating a compensatory action item to address a discrepancy between the access policy and the access rules.

### BACKGROUND

The use of access control equipment for selectively restricting physical access to secured areas is widespread. Access control equipment typically includes at least one door controller, door control devices (e.g., door sensors, door monitors, door strike relays, magnetic door locks, etc.), and identification card readers. The door controller may be a computer system that has (and/or has access to) a database of access rules, and it may be responsible for applying the access rules. The door control devices are used to monitor doors states and to unlock doors when required. Identification card readers communicate with user identification cards and retrieve the users' credentials. That information is conveyed to the door controller, for example by the means of an RS485 bus. The door controller may then decide to unlock the door or not. The door controller(s) may be connected to an access control server, which is often over an IP network connection. The access control server has a database of the access rules, and the access control server may push the current version of the access rules to the door controller(s) and/or the door controller(s) may connect to the access control server to access the database when making access control decisions. The door controller(s) can record the access control decisions as access events, which can be transmitted to the access control server, and an access control log of these access control events may from time-to-time be manually reviewed by an auditor conducting access control audits.

An organization may have a higher-level access policy document that is written in a human understandable language, which is used to create the access rules, and generally specifies who has access, when they have access and what they have access thereto. For example, the human language access policy document may state that manufacturing floor employees have access to the manufacturing floor doors during business hours, executives always have access to all doors, that visitors must be escorted by an employee, etc. Authorized personnel, such as an IT professional, applies the access policy document to create the specific access rules in the database at the access control server via their computer, and these access rules are ultimately implemented at the door controllers. Such implementation of the access policy document into access rules may include creating cardholder groups, for example, for different types of employees and for visitors, adding new or existing cardholders to one or more cardholder groups, and creating access rules for each door in a building for one or more cardholders or cardholder groups.

However, the implemented access rules do not necessarily respect the human language access policy document because of at least four possible opportunities for distortions. First, errors may be made when creating the specific instructions for implementing the access rules from the human language of the policy document. Second, a user may make a mistake when creating the access rules in the system, if the user does not implement an access rule directly as specified. Third, the policy might change, and the user may fail to propagate the change to the access control equipment. Four, the complexity of the policy is such that the equipment cannot implement it. For example, the IT professional implementing the access policy document could make a mistake when adding a cardholder or in creating the access rules or groups, even if the intention is to respect the access policy, leading to a critical mismatch between the policy and the rules. In other cases, the access control equipment, such as the door controller, may have bugs that allow for contravening access rules. Furthermore, some hardware cannot implement some access policies due to hardware limitations. For example, the access policy document could specify that important visitors are allowed on showroom floors but must be escorted by an executive, and this policy cannot be implemented at the door controller level due to hardware limitations in this example. Moreover, by the time an auditor has reviewed the access control logs it is often too late to take any meaningful action as a security threat or violation has typically already occurred.

As such, there is a need for additional and/or improved access control systems and/or methods, for example, to address discrepancies between a human language access policy document and implemented access rules at the access control equipment.

### SUMMARY

The following presents a simplified summary of one or more implementations in accordance with aspects of the present disclosure, in order to provide a basic understanding of such implementations, without limiting the embodiments presented within the present disclosure.

An access control computing system, for example, such as a server and/or cloud computing infrastructure, is presented herein for detecting discrepancies between an access policy and implemented access rules at access control equipment, and for generating compensatory action items to address the discrepancies.

An organization may have a policy document written in a human understandable language. The human language policy document may include human expressions that can be translated to machine-enforceable access control policies in a high-level domain-specific language, for example, such as eXtensible Access Control Markup Language (XACML) or based on Attribute Based Access Control (ABAC).

In some implementations, the high-level human language policy document may be converted to a lower lever hardware language without introducing errors or with minimizing errors. To compile the access rule, the access control computing system may determine the capabilities of the target access control equipment, map the policies to the capabilities of the target access control equipment, and automatically detect or generate a warning when the mapping is impossible. For example, there may be equipment description language that specifies the capabilities of the access control equipment and there may be rules that specify how to map policy to a particular piece of access control equipment, which may be used to determine when a policy cannot be applied. The access control computing system may be configured to detect any errors introduced during the conversion and/or to indicate when any policy is too complex to be implemented by the access control equipment, such that any policy violations do not go undetected. In some cases, if a door controller or access control panel is unable to accommodate a complex policy (e.g., a very important person (VIP) can enter a showroom only when accompanied by an executive), the system may propose an upgrade (e.g., add a Synergis™ Cloud Link hardware appliance provided by Genetec Inc.) that is able to implement complex policy. In some cases, when a specific piece of hardware is unable to implement a complex policy, the access control decision may be escalated to another piece of hardware that is capable of making the access control decisions (e.g., the Synergis™ Cloud Link hardware appliance) and/or to a server of access control computing system that is capable of making the access control decisions.

In general, the access control computing system receives access events from access control equipment controlling physical access to a secured premise, such as an office building having office doors. The access control equipment typically includes at least one door controller and one or more readers in communication with each door controller. Each door controller is configured to receive requests from the reader(s), such as when a person presents their card, badge or the like to a particular reader at an access point, such as an office door. Each door controller can control access to grant or deny access to the secured premises based on the implemented access rules for the secured premises. Each door controller can generate the access events in response to the requests from the one or more readers and can generate the access events based on its access control decisions to grant or deny access at each access point.

In one or more implementations, the access control computing system has a policy validation engine that is used to compare the received access events from the access control equipment to the access policy having various clauses for the secured premises. The policy validation engine is configured to detect any access events that violate the access policy and generate action items for compensatory actions that are to be taken in response to the access events that violate the access policy. For example, the compensatory action can be a modification of the access rule that violates the policy. By way of another example, the compensatory action can be sending security personnel to the access point associated with the access event that violates the access policy.

The access events received at the policy validation engine might not include the access rules that are used in making the access control decisions to either grant or deny access to the access points. As such, the policy validation engine may emulate access to a particular access point when it detects that a particular access event violates the access policy in order to identify the access rule that led to the access policy being violated. The policy validation engine may also compare the violating access rule to the access policy in order to make a recommendation to change the violating access rule such that it will conform to the access policy. In some embodiments, the clauses of the access policy may include attribute-based expressions, and the attributes associated with the access events may be compared to the access policy to determine if the access policy is violated.

The policy validation engine may also be configured to detect failure to comply with a two-person policy clause, such as a visitor escort policy clause, that is difficult or not possible to be implemented with access rules at the door controller(s). Accordingly, when a two-person policy clause is violated, the policy validation engine may send an alert such that security personnel can respond to the policy violation that the access control equipment is unable to detect.

To this end, the present disclosure provides methods, systems, and computer-readable media for detecting policy violations and generating compensatory action items.

According to at least one embodiment, there is disclosed a method performed by an access control computing system, the method comprising receiving access events from access control equipment controlling access to a secured premises, the access control equipment includes a door controller and one or more readers in communication with the door controller, the door controller configured to receive requests from the one or more readers and to control access to the secured premises based on a plurality of access rules for the secured premises, the door controller generating the access events based on the requests from the one or more readers; comparing each access event of the access events to an access policy subsequent to receiving each access event, the access policy comprising a plurality of clauses for the secured premise, and detecting that a particular access event of the access events violates at least one clause of the access policy; and generating a compensatory action item for the particular access event that violates the access policy.

In some embodiments, each access event comprises a timestamp, a user identifier, an access control decision and an access point identifier. In some embodiments, the method further comprises identifying a particular access rule of the plurality of access rules that resulted in the access control decision of the particular access event that violates the access policy. In some embodiments, the compensatory action item comprises a request for user modification of the particular access rule that resulted in the access control decision of the particular access event that violates the access policy.

In some embodiments, the method further comprises comparing the particular access rule to the at least one clause of the access policy that is violated by the particular access event to determine a recommendation for the user modification of the particular access rule based on a difference between the particular access rule and the at least one clause that is violated by the particular access event. In some embodiments, the compensatory action item comprises the recommendation for the user modification of the particular access rule.

In some embodiments, identifying the particular access rule comprises emulating access to an access point corresponding to the access point identifier with the user identifier of the particular access event at a time corresponding to the timestamp of the particular access event. In some embodiments, each access event further comprises an identifier of an access rule corresponding to the access control decision. In some embodiments, identifying the particular access rule comprises obtaining the particular access rule from the plurality of access rules using the identifier of the access rule.

In some embodiments, generating the compensatory action item comprises transmitting an alert to a computing device in communication with the access control computing system to notify a user of the computing device to take a compensatory action. In some embodiments, the compensatory action item comprises a notification to send security personnel to an access point associated with the particular access event.

In some embodiments, the plurality of clauses of the access policy comprises a two-person policy clause. In some embodiments, detecting that the particular access event violates the access policy comprises detecting for the particular access event that the two-person policy clause of the access policy applies to at least one of a user and an access point corresponding to the particular access event, and determining failure of the two-person policy clause based on an absence of another access events occurring within a timeframe surrounding the particular access event. In some embodiments, the two-person policy clause is a visitor escort policy clause indicating that the user associated with the particular access event must be escorted by an authorized user for the access point associated with the particular access event.

In some embodiments, each clause in the access policy has a compensatory action associated therewith. In some embodiments, generating the compensatory action item is based on the compensatory action of the at least one clause violated by the particular access event.

In some embodiments, comparing comprises identifying a subset of clauses of the plurality of clauses of the access policy based on the user identifier of the particular access event, and processing the subset of clauses to detect the particular access event that violates the access policy. In some embodiments, comparing comprises identifying a subset of clauses of the plurality of clauses of the access policy based on the access point identifier of the particular access event, and processing the subset of clauses to detect the particular access event that violates the access policy.

In some embodiments, comparing each access event to the access policy subsequent to receiving each access event occurs in real-time or near real-time. In some embodiments, comparing each access event to the access policy subsequent to receiving each access event occurs at a scheduled time.

In some embodiments, the plurality of clauses of the access policy comprises a particular clause that is incompatible with the access control equipment such that the particular clause is unsuitable to be implemented as a corresponding rule in the plurality of access rules.

In some embodiments, detecting that the particular access event violates the access policy comprises detecting that the particular access event violates the particular clause that is unsuitable to be implemented as a corresponding rule in the plurality of access rules.

According to at least one embodiment, there is disclosed a computing system comprising: at least one processor; and at least one non-transitory computer-readable memory having stored thereon program instructions executable by the at least one processor for: receiving access events from access control equipment controlling access to a secured premises, the access control equipment includes a door controller and one or more readers in communication with the door controller, the door controller configured to receive requests from the one or more readers and to control access to the secured premises based on a plurality of access rules for the secured premises, the door controller generating the access events based on the requests from the one or more readers; comparing each access event of the access events to an access policy subsequent to receiving each access event, the access policy comprising a plurality of clauses for the secured premise, and detecting that a particular access event of the access events violates at least one clause of the access policy; and generating a compensatory action item for the particular access event that violates the access policy.

In some embodiments, the program instructions are further executable by the at least one processor for identifying a particular access rule of the plurality of access rules that resulted in the access control decision of the particular access event that violates the access policy. In some embodiments, the program instructions are further executable by the at least one processor for comparing the particular access rule to the at least one clause of the access policy that is violated by the particular access event to determine a recommendation for the user modification of the particular access rule based on a difference between the particular access rule and the at least one clause that is violated by the particular access event.

According to at least one embodiment, there is disclosed a non-transitory computer-readable storage medium having stored thereon program instruction which, when executed, cause at least one processor to: receive access events from access control equipment controlling access to a secured premises, the access control equipment includes a door controller and one or more readers in communication with the door controller, the door controller configured to receive requests from the one or more readers and to control access to the secured premises based on a plurality of access rules for the secured premises, the door controller generating the access events based on the requests from the one or more readers; compare each access event of the access events to an access policy subsequent to receiving each access event, the access policy comprising a plurality of clauses for the secured premise, and detect that a particular access event of the access events violates at least one clause of the access policy; and generate a compensatory action item for the particular access event that violates the access policy. In some embodiments, the program instructions which, when executed, further cause the at least one processor to: identify a particular access rule of the plurality of access rules that resulted in the access control decision of the particular access event that violates the access policy. In some embodiments, the program instructions which, when executed, further cause the at least one processor to compare the particular access rule to the at least one clause of the access policy that is violated by the particular access event to determine a recommendation for the user modification of the particular access rule based on a difference between the particular access rule and the at least one clause that is violated by the particular access event, and wherein the compensatory action item comprises the recommendation for the user modification of the particular access rule. In some embodiments, the plurality of clauses of the access policy comprises a two-person policy clause, and wherein the program instructions which cause the at least one processor to detect that the particular access event violates the access policy further comprises program instructions which, when executed, cause the at least one processor to: detect for the particular access event that the two-person policy clause of the access policy applies to at least one of a user and an access point corresponding to the particular access event; and determine failure of the two-person policy clause based on an absence of another access events occurring within a timeframe surrounding the particular access event. In some embodiments, the program instructions which cause the at least one process to compare further comprises program instructions which, when executed, cause the at least one processor to: identify a subset of clauses of the plurality of clauses of the access policy based on the user identifier of the particular access event; and process the subset of clauses to detect the particular access event that violates the access policy. In some embodiments, the program instructions which cause the at least one processor to compare further comprises program instructions which, when executed, cause the at least one processor to: identify a subset of clauses of the plurality of clauses of the access policy based on the access point identifier of the particular access event; and process the subset of clauses to detect the particular access event that violates the access policy. In some embodiments, the program instructions which cause the at least one processor to detect that the particular access event violates the access policy further comprise program instructions which, when executed, cause the at least one processor to detect that the particular access event violates the particular clause that is unsuitable to be implemented as a corresponding rule in the plurality of access rules.

Any of the above features may be used together in any suitable combination.

### BRIEF DESCRIPTION OF THE FIGURES

Reference is now made to the accompanying figures in which:

FIG. 1 is a block diagram of an example access control system for detecting a discrepancy between access rules of access control equipment and an access policy, in accordance with one or more embodiments;

FIG. 2A is a diagram illustrating a graphical user interface (GUI) of an example window element for adding clauses to an access policy, in accordance with one or more embodiments;

FIG. 2B is a diagram illustrating a first specific and non-limiting example of a clause added to the access policy in the window element of FIG. 2A, in accordance with one or more embodiments;

FIG. 2C is a diagram illustrating a second specific and non-limiting example of a clause added to the access policy in the window element of FIG. 2A, in accordance with one or more embodiments;

FIG. 2D is a diagram illustrating a third specific and non-limiting example of a clause added to the access policy in the window element of FIG. 2A, in accordance with one or more embodiments;

FIG. 2E is a diagram illustrating a fourth specific and non-limiting example of a clause added to the access policy in the window element of FIG. 2A, in accordance with one or more embodiments;

FIG. 2F is a diagram illustrating a fifth specific and non-limiting example of a clause added to the access policy in the window element of FIG. 2A, in accordance with one or more embodiments;

FIG. 2G is a diagram illustrating a specific and non-limiting example of a clause illustrating an example attribute-based expression, in accordance with one or more embodiments;

FIG. 3A is a diagram illustrating a first specific and non-limiting example of the access policy, in accordance with one or more embodiments;

FIG. 3B is a diagram illustrating a second specific and non-limiting example of the access policy, in accordance with one or more embodiments;

FIG. 3C is a diagram illustrating a third specific and non-limiting example of the access policy, in accordance with one or more embodiments;

FIG. 3D is a diagram illustrating a specific and non-limiting example of a clause of the access policy of FIG. 3A which is referencing another data source, in accordance with one or more embodiments;

FIG. 3E is a diagram illustrating another specific and non-limiting example of a clause of the access policy of FIG. 3A, in accordance with one or more embodiments;

FIG. 4A is a diagram illustrating a GUI of an example window element for adding rules to the access rules, in accordance with one or more embodiments;

FIG. 4B is a diagram illustrating a specific and non-limiting example of a rule added to the access rules in the window element of FIG. 4A, in accordance with one or more embodiments;

FIG. 5A is a diagram illustrating a first specific and non-limiting example of the access rules, in accordance with one or more embodiments;

FIG. 5B is a diagram illustrating a specific and non-limiting example of database tables for storing the access rules, in accordance with one or more embodiments;

FIG. 5C is a diagram illustrating a second specific and non-limiting example of the access rules, in accordance with one or more embodiments;

FIG. 6A is a diagram illustrating a first specific and non-limiting example of an access event, in accordance with one or more embodiments;

FIG. 6B is a diagram illustrating a second specific and non-limiting example of an access event, in accordance with one or more embodiments;

FIG. 6C is a diagram illustrating a third specific and non-limiting example of an access event, in accordance with one or more embodiments;

FIG. 6D is a diagram illustrating a fourth specific and non-limiting example of an access event, in accordance with one or more embodiments;

FIG. 6E is a diagram illustrating a fifth specific and non-limiting example of an access event, in accordance with one or more embodiments;

FIG. 7A is a diagram illustrating a policy validation engine processing access events and generating a compensatory action item, in accordance with one or more embodiments;

FIG. 7B is a diagram illustrating a GUI illustrating a notification for a compensatory action to be performed, in accordance with one or more embodiments;

FIG. 7C is a diagram illustrating a GUI illustrating an alarm and prompted video as a compensatory action, in accordance with one or more embodiments;

FIG. 7D is a diagram illustrating a notification that the access policy has been violated and proposing modification to the access rules as a compensatory action, in accordance with one or more embodiments;

FIG. 7E is a diagram illustrating a notification that the access policy has been violated and proposing a new rule be added to the access rules as a compensatory action, in accordance with one or more embodiments;

FIG. 8A is a block diagram of an example of processing circuitry of the access control system of FIG. 1, in accordance with one or more embodiments;

FIG. 8B is a block diagram of an example of a variant of the processing circuitry of the access control computing system of FIG. 8A, in accordance with one or more embodiments;

FIG. 8C is a block diagram of another example access control system for detecting a discrepancy between access rules of access control equipment and an access policy, in accordance with one or more embodiments;

FIG. 8D is a block diagram of yet another example access control system for detecting a discrepancy between access rules of access control equipment and an access policy, in accordance with one or more embodiments;

FIG. 9 is a flowchart illustrating an example method for detecting that a particular access event violates an access policy and for generating a compensatory action item of the particular access event that violated the access policy, in accordance with one or more embodiments;

FIG. 10A is a flowchart illustrating a first example of the step of comparing access events to the access policy of the method of FIG. 9, in accordance with one or more embodiments;

FIG. 10B is a flowchart illustrating a second example of the step of comparing access events to the access policy of the method of FIG. 9, in accordance with one or more embodiments;

FIG. 10C is a flowchart illustrating an example of the step of detecting that a particular access event violates the access policy of the method of FIG. 9, in accordance with one or more embodiments;

FIG. 10D is a flowchart illustrating an example of the step of identifying a particular access rule that correspond to the particular access event that violates the access policy of the method of FIG. 9, in accordance with one or more embodiments;

FIG. 11 is a flowchart illustrating an example method for detecting a discrepance between an access policy and access rules, in accordance with one or more embodiments; and

FIG. 12 is a schematic diagram of an example computing device, in accordance with one or more embodiments.

It will be noted that throughout the appended drawings, like features are identified by like reference numerals.

### DETAILED DESCRIPTION

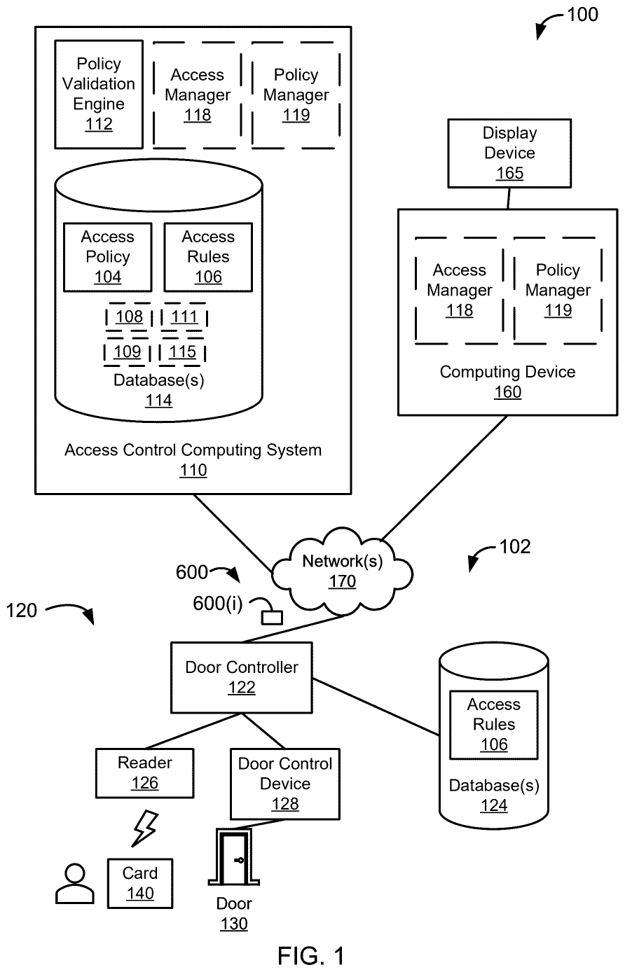

With reference to FIG. 1, there is illustrated an example access control system 100 including an access control computing system 110 in communication with access control equipment 120 for controlling physical access to a secured premises 102. In this example, the access control computing system 110 is configured to detect discrepancies between an access policy 104 for the secured premises 102 and access rules 106 implemented by the access control equipment 120, and to generate action items for taking compensatory actions to address the discrepancies. The abovementioned and other features are further described herein.

The headings used herein are for organizational purposes only and are not meant to be used to limit the scope of the description or the claims. Implementations described under any header may be combined with any other implementation described under the same heading and/or under any other headings.

### Secured Premises

The secured premises 102 may include one or more spaces, one or more workspaces, one or more office buildings, one or more factories, one or more research facilities, one or more educational facilities, a combination of two or more thereof, or any other building, set of multiple buildings, any other facility, set of multiple facilities, structure, set of multiple structures, or space where access control may be desired. The secured premises 102 may include one or more secured spaces and one or more unsecured spaces. The secured premises 102 may be a single location, for example, such as a single building. The secured premises 102 may be a single barrier, for example, such as single door. The secured premises 102 may include multiple locations, for example, such as multiple buildings and/or multiple doors. In this example, the secured premises 102 includes a door 130, and the access control equipment 120 is configured to control access through the door 130. The term “door” may include any suitable door (e.g., office door, workspace door, factory door, facility door, garage door, etc.), parking gate, turnstile, or other structure or barrier that may move (by swinging or sliding, for example) or otherwise control access between locations on opposite sides of the barrier where access control may be desired. While only one door 130 is shown in FIG. 1, in some embodiments, there may be multiple doors at different locations of the secured premises 102, for example in a same building or in different buildings.

### Access Control Computing System

The access control computing system 110 may include one or more servers, which may be located remote from or within the secured premises 102. For example, the access control computing system 110 can include an on-premises server located within the secured premises 102. In some embodiments, the access control computing system 110 includes cloud computing infrastructure remote from the secured premises 102. The access control computing system 110 may include at least one on-premises server and one or more remote servers (e.g., cloud computing infrastructure). The access control computing system 110 may include any suitable computing device(s) and/or system(s).

The cloud computing infrastructure may include any suitable hardware and software elements for enabling cloud computing and/or for providing cloud services. The cloud computing infrastructure may include one or more servers, one or more computers, system and/or device, one or more network devices, memory, one or more storage devices, one or more data lakes, one or more data pools, one or more data systems and/or one or more data clusters, and/or any other suitable hardware and/or software elements. The cloud computing infrastructure may include an interface for users to access virtual resources. The virtual resources may mirror a physical infrastructure, with components like servers, network devices, memory and storage.

The access control computing system 110 may include one or more databases 114, herein generally referred to as the database(s) 114. The database(s) 114 may have stored therein the access rules 106. The database(s) 114 may have stored therein the access policy 104. The database storing the access policy 104 may be the same or separate from the database storing the access rules 106. In other words, the access policy 104 and the access rules 106 may be stored in the same database or in separate databases. The database(s) 114 may have stored therein additional information. In some embodiments, the database(s) 114 may have stored therein user information 108, premises information 109, schedule information 111, compensatory action information 115, and/or any other suitable information. The database(s) 114 storing the user information 108, premises information 109, schedule information 111, the compensatory action information 115, and/or any other suitable information may be the same or separate from each other and may be the same or separate from the database storing the access policy 104 and/or access rules 106. The database(s) 114 may be included as part of a computing device (e.g., a server) of the access control computing system 110. The database(s) 114 may be remote from the access control computing system 110 and the database(s) 114 is/are accessible by the access control computing system 110. In some embodiments, the databases 114 includes one or more databases local to the access control computing system 110 and one or more databases remote from the access control computing system 110.

The access control computing system 110 may push a current version of the access rules 106 stored in the database(s) 114 to the access control equipment 120. The access control computing system 110 may push any additional information (e.g., the user information 108, premises information 109, schedule information 111, etc.) stored in the database(s) 114 to the access control equipment 120. In some embodiments, the access control equipment 120 may connect to the access control computing system 110 to access the database(s) 114 and information stored therein (e.g., the assess rules 106, the user information 108, premises information 109, schedule information 111, etc.) when making access control decisions. In general, the access control equipment 120 makes access control decisions based on the access rules 106, which may also be based on the user information 108 and/or any other suitable information.

The access control computing system 110 may receive a plurality of access events 600 from the access control equipment 120. In the illustrated example, the door controller 122 transmits the access events 600, and in particular is shown transmitting an access event 600(i) over one or more networks 170 to the access control computing system 110. In some embodiments, the access control computing system 110 comprises a policy validation engine 112 that can process the access events 600 to detect if any one of the access events 600 violates the access policy 104, and to generate a compensatory action item for a compensatory action that is to be taken when a violation occurs. The compensatory action item may be transmitted to a computing device, such as the computing device 160 to notify a user of the compensatory action that is to be taken.

In some embodiments, the access control computing system 110 comprises an access manager 118 that can be used to set up and/or modify the access rules 106 implemented by the access control equipment 120. In some embodiments, the access control computing system 110 comprises a policy manager 119 that can be used to set up and/or modify the access policy 104. The access manager 118 and the policy manager 119 may be the same or separate software running on the access control computing system 110. In some embodiments, the access manager 118 and/or the policy manager 119 may be software running on the computing device 160, which may be used to set up and/or modify the access policy 104 and/or the access rules 106 at the access control computing system 110. The access manager 118 and the policy manager 119 may be the same or separate software running on the computing device 160. In some embodiments, the access manager 118 and/or the policy manager 119 include software running on both the access control computing system and the computing device 160. For example, the access control computing system 110 may be implemented as an on-premises server running the Genetec™ Security Center unified security platform provided by the Applicant, and a computing device 160 running the Genetec™ Security Desk application to connect to the access control computing system 110 to setup and/or modify the access policy 104 and/or the access rules 106. In some embodiments, the access control computing system 110 is implemented with cloud computing infrastructure running Genetec™ Security Center SaaS provided by the Applicant, and a user may use a web browser and/or a client application of the computing device 160 to connect to the access control computing system 110 to set up and/or modify the access policy 104 and/or the access rules 106.

### Access Control Equipment

The access control equipment 120 may include at least one door controller 122, at least one door control device 128, and at least one reader 126. The access control equipment 120 is configured to control access to the secured premises 102 based on at least the access rules 106 for the secured premises 102. In general, the at least one door controller 122 receives requests from the at least one reader 126 and controls access to the secured premises 102 based the access rules 106, and the at least one door controller 122 generates the access events 600 based on the requests from the at least one reader 126.

The access control equipment 120 may include other devices and/or systems for generating access events. For example, the access control equipment 120 may include one or more camera and/or one or more devices and/or system performing video analytics and generating access events (not illustrated in FIG. 1). For example, access events may be generated that pertain to counting or identifying persons or detecting entry into restricted areas.

### Door Controller

The door controller 122 may include a computer system and/or computer device that has (and/or has access to) the access rules 106, and it may be responsible for applying the access rules 106. The access rules 106 at the door controller 122 may be a copy of the access rules 106 at the access control computing system 110 and may be stored in at least one database 124, which is generally referred to herein as the database(s) 124. The database(s) 124 may further include additional information. For example, the database(s) 124 may include a copy of the user information 108 and the door controller 122 may use the user information 108 to look-up a user in order to apply the access rules 106 applicable to that user. In some embodiments, the door controller 122 accesses the access rules 106 stored at the access control computing system 110 when making access control decisions. The door controller 122 may receive requests from one or more readers, such as the reader 126 and control access through one or more access points, such as the door 130. The door controller 122 may receive a request from the reader 126 and control access by granting or denying access to the secured premises 102 based on comparing the request to the access rules 106 for the secured premises 102. The door controller 122 may generate the access event 600(i) based on the request from the reader 126. More specifically, the door controller 122 may generate the access event 600(i) based on the access control decision to grant or deny access made in response to the request from the reader 126. The door controller 122 may transmit the access event 600(i) to the access control computing system 110. The access event 600(i) may be stored in the database(s) 124 of the door controller 122 and/or accessible by the door controller 122. The database where the door controller 122 stores the access event 600(i) therein may be the same or may be different from the database where the access rules 106 are stored therein. The door controller 122 may be referred to as a “controller”, an “access control controller”, or an “access control unit”. The “request” or “requests” from the reader 126 may be referred to as an “access request” or “access requests”, respectively. In some embodiments, the door controller 122 may include Synergis™ Cloud Link hardware appliance provided by the Applicant or any other suitable networked appliance and/or microserver. In some embodiments, the door controller 122 may be connected to the Synergis™ Cloud Link hardware appliance provided by the Applicant or any other suitable networked appliance and/or microserver. While only one door controller 122 is shown in FIG. 1, in some embodiments, there may be multiple door controllers, where each door controller is connected to one or more readers. Similarly, while only one access event 600(i) is shown in FIG. 1, each door controller may be generating multiple access events 600 in response to multiple requests from one or more readers.

### Door Control Device

The door control device 128 may be used to monitor the state of the door 130 and/or to unlock the door 130 when required. The door control device 128 may include one or more devices such as: door sensors, door monitors, door locks, door strike relays, magnetic door locks, turnstile control mechanism, or any other suitable control mechanism and/or device. The door control device 128 may be connected to the door controller 122 such that the door controller 122 can monitor the state of the door 130 and/or unlock the door 130 when required. The door control device 128 may control access through a doorway of the door 130 between a location on a first side of the door 130 and another location on a second side of the door 130 opposite the first side of the door 130. The door controller 122 may control the door control device 128 by transmitting one or more signals to the door control device 128. The door control device 128 may be operable to hold the door 130 in a closed position to prevent access through the doorway of the door 130. The door control device 128 may also allow access through the doorway by releasing the door 130 and allowing the door 130 to open into an open position, for example in response to receiving one or more signals from the door controller 122. For example, the door controller 122 in response to making an access control decision to grant access to the door 130, the door controller 122 can transmit a signal to the door control device 128 to unlock the door. The connection of the door control device 128 may be through a local bus or link, or it may be over any other suitable network. Over this link, bus and/or connection, the door controller 122 may send instructions to the door control device 128 to unlock the door 130, for example. While only one door control device 128 is shown in FIG. 1, in some embodiments, there may be multiple door control devices, where each control device is associated with a door, for example.

### Reader

In this illustrated example of FIG. 1, the reader 126 communicates with a user identification card 140 presented at the reader 126 and retrieves the user's credentials. That information is conveyed to the door controller 122, for example by the means of an RS485 bus, a network connection or other communication mechanism. The reader 126 may transmit a signal to the door controller 122 corresponding to a request for access with the retrieved credential information, and which is received at the door controller 122. The door controller 122 receives the request from the reader 126 and may then decide to unlock the door 130 or not based on the request and the access rules 106.

While a contactless smart card 140 is shown in FIG. 1, access requests may be made in various manners. The reader 126 may include a card reader, such as contactless card reader or a contact card reader, a pin pad, a fingerprint scanner, a retina scanner, an iris scanner, a camera for capturing facial images, a license plate recognition (LPR) camera, a mobile device, an Internet Protocol (IP) reader, a reader configured to communicate with and/or read information from a mobile computing device (e.g., a mobile phone), and/or any other suitable reader. While only one reader 126 is shown in FIG. 1, in some embodiments, there may be multiple readers, where each reader is associated with a door, for example. In embodiments where multiple readers are provided, the readers may be any suitable combination of different types, makes, and/or models of readers.

In some embodiments, the reader 126 may be a mobile computing device as described in U.S. Pat. No. 12,033,450 issued to Genetec Inc., the contents of which are hereby incorporated by reference. For example, a mobile computing device may receive an identifier of the door 130 and transmit an access request to the access control computing system 110. The access request may comprise data representing at least an identifier of the door and an access code. The access control computing system 110 may receive the access request from the mobile computing device, and in response to the request, allows or denies access through the door 130. The access control computing system 110 may then generate the access event based on the access request and the access control decision to allow or deny access.

### Computing Device

The computing device 160 may include any suitable computer, such as a workstation, a portable computer, a tablet computer, a smartphone, a smart watch, smart glasses, or the like. An authorized user (e.g., an information technology (IT) professional, security personnel, etc.) may use the computing device 160 to connect to the access control computing system 110 and to implement the access policy 104, the access rules 106 and/or to be notified of any compensatory action items. The authorized user may be any suitable user that is authorized to implement and/or modify the access policy 104, the access rules 106 and/or to be notified of any compensatory action items. The authorized user may authenticate with the computing device 160, such as, for example, by entering in a username and password, in order to be authorized to implement the access policy 104, the access rules 106 and/or to be notified of any compensatory action items. The computing device 160 may provide a user interface for interfacing, interacting and/or controlling the access control computing system 110. The computing device 160 may function largely as a client, e.g., using a web browser or client application. In some embodiments, the access control computing system 110 may provide a user interface for interacting therewith, in which case the computing device 160 may be omitted. A display device 165 may be connected to the computing device 160. In some embodiments, the computing device 160 comprises the display device 165. The display device 165 may be a cathode ray tube display device, a light emitting diode (LED) display device, an organic light-emitting diode (OLED) display device, a liquid crystal display (LCD) display device, a touch screen, or any other suitable display device. In embodiments where the computing device 160 is omitted, the display device 165 may be connected to the access control computing system 110 or the access control computing system 110 may comprise the display device 165. While only one computing device 160 is shown in FIG. 1, in some embodiments, there may be multiple computing devices. For example, one computing device may be used to setup the access policy 104 and/or access rules 106 by a first authorized user, another computing device may receive the compensatory action items operated by a second authorized user. By way of another example, a first computing device may be used to setup the access policy 104 by a first user, a second computing device may be used to setup the access rules 106 by a second user, a third computing device may receive the compensatory action items operated by a third user.

### Network

Any communication between the access control computing system 110, the access control equipment 120 (e.g., the door controller 122), the computing device 160 and/or any other suitable device(s), may be over one or more networks 170, which is generally referred herein to as the network(s) 170. The network(s) 170 may comprise one or more public networks (e.g., the Internet) and/or one or more private networks. The network(s) 170 may comprise one or more of a personal area network (PAN), local area network (LAN), mesh network, metropolitan area network (MAN), wide area network (WAN), wireless network, Wi-Fi network, Bluetooth network, cellular network and/or any other suitable computer network(s). In some embodiments, the network(s) 170 include at least one network that is located within the secured premises 102.

### Access Policy

The access policy 104 may define the conditions under which access to the secured premises 102 may take place. The access policy 104 may comprise a plurality of clauses. In general, an access policy may be said to include policies and/or rules. For example, rules may be grouped into policies. However, in this document, for clarity reasons and/or to distinguish the access policy 104 from the access rules 106, the access policy 104 is typically said to comprises clauses. Each clause may include one or more conditions for specifying access to the secured premises 102.

The access policy 104 may be created from a high-level human language access policy document, generally referred to herein as the “policy document”. The policy document may be created by management of an organization, and which generally defines access control for the organization. Management may create the policy document in the form of a Word document, a PDF document or in any other suitable format. In some cases, a policy document does not exist. In some embodiments, an authorized user, such a person from management, may create the access policy 104, using the embodiments described herein, and may optionally export the access policy 104 to create a policy document that may then be used to implement the access rules 106, for example.

The policy manager 119 may provide a graphical user interface (GUI) for allowing the authorized user to create the access policy 104. Once the authorized user has requested to create a new access policy, for example, by selecting a new access policy user interface element, such as, a “new access policy” button, the authorized user may then create a new clause for the new access policy, which in this example is the access policy 104. The authorized user may then add a new clause by selecting a new clause user interface element, for example, such as a “new clause” button. The authorized user may then add the new clause by adding one or more conditions to the clause.

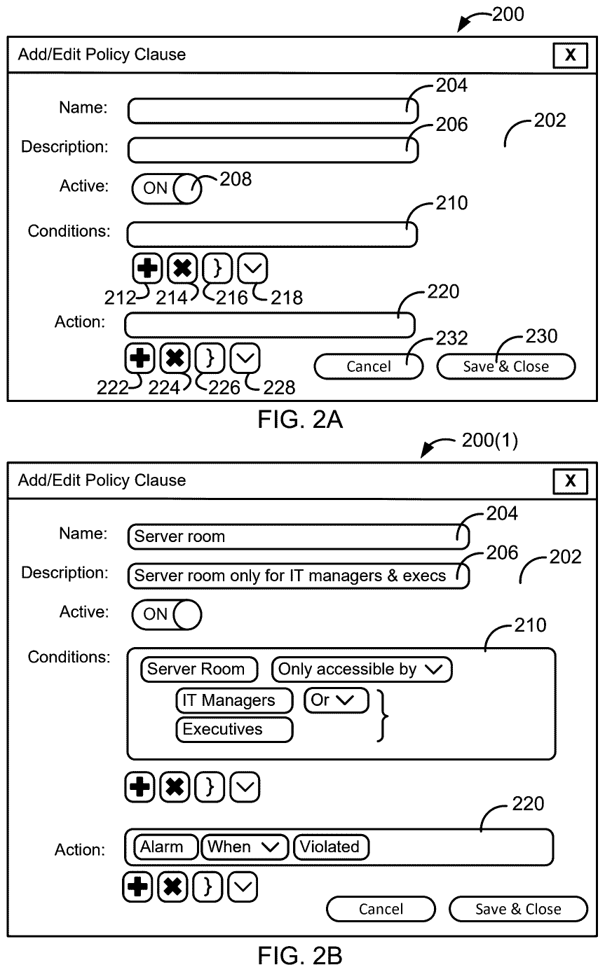

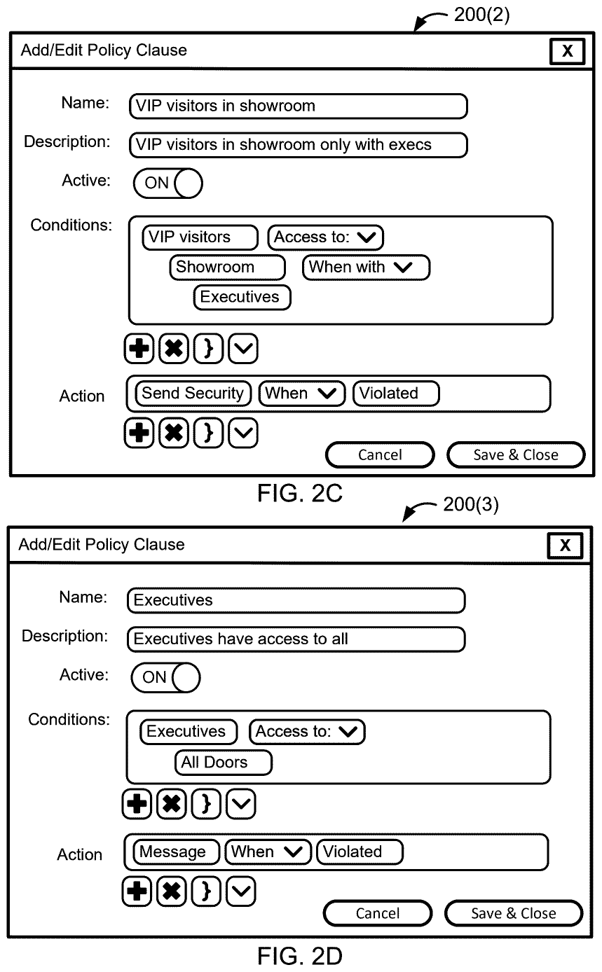

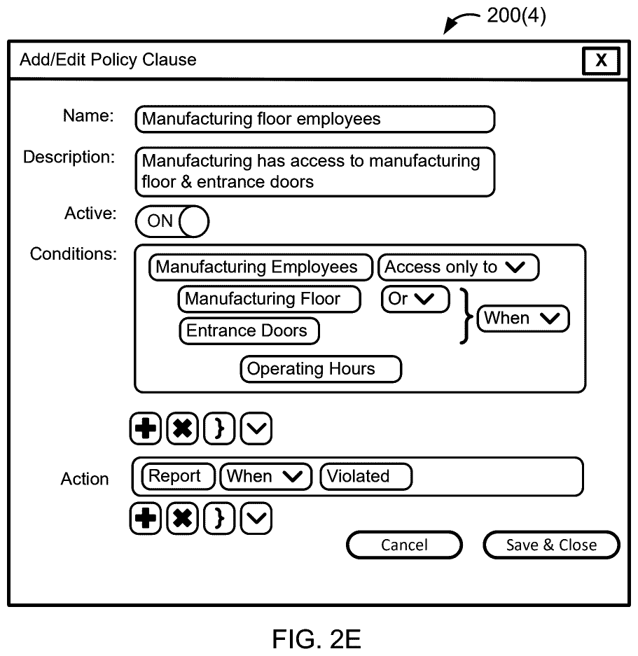

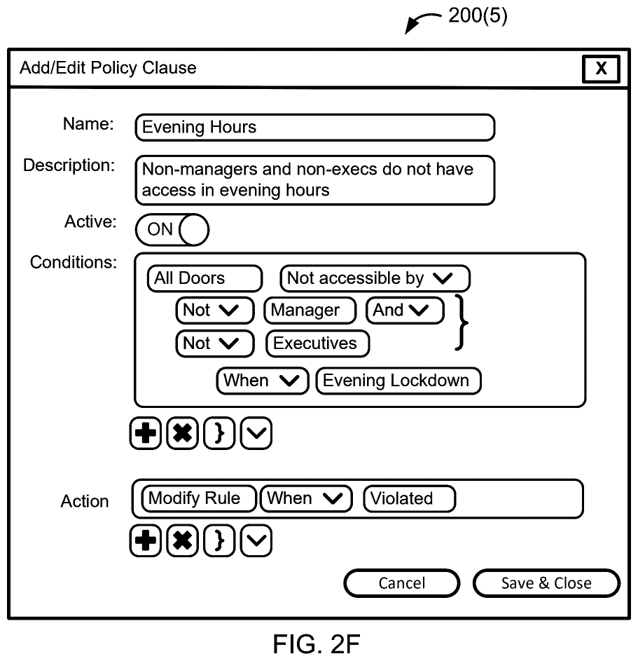

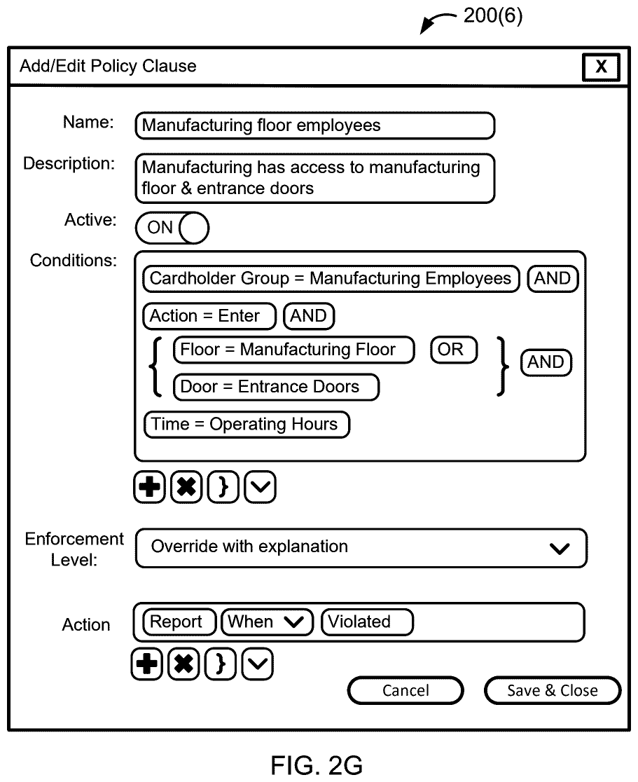

With reference to FIG. 2A, there is illustrated an example of a window element 202 of a GUI 200 for adding a new clause to the access policy 104. In this example, the window element 202 includes: a name input box 204 for providing a name to the clause; a description input box 206 for providing a description to the clause (or to add the actual language for the clause from the policy document); a toggle button 208 to select between “ON” and “OFF” to set the clause as an active clause or disabled clause; a conditions input box 210 for adding one or more conditions to the clause; a plurality of condition interface elements 212, 214, 216, 218 for defining the clause by providing the options to add, remove, group and constrain conditions and/or entities; an action input box 220 for adding at least one action to the clause; and a plurality of action interface elements 222, 224, 226, 228 for defining the action by providing the options to add, remove, group and constrain actions and/or conditions; a selectable button 230 to save the clause and close the window element 202; and a selectable button 232 to cancel and close the window element 202.

By way of example, the authorized user may take the policy document and use the window element 202 to create each clause of the access policy 104. In this specific and non-limiting example, the policy document recites: (1) only IT managers and executives can enter the server room; (2) VIP visitors must be escorted by an executive when visiting showrooms; (3) executives always have access to all doors; (4) manufacturing floor employees have access to the manufacturing floor doors and entrance doors during operating hours of Monday to Friday, 7AM to 7PM, and not on holidays; and (5) non-managers and non-executives cannot have access during a lockdown period of each day between 11PM and 5AM. The policy document would typically vary depending on implementation and/or on each organization needs, and the example provided is a simplified example for illustrative purposes. The authorized user may take this policy document and use the computing device 160 to create the access policy 104 that is stored in the database(s) 114 of the access control computing system 110 by interfacing with the policy manager 119 via the window element 202, for example.

With additional reference to FIG. 2B, there is illustrated a first example 200(1) of a first clause created in the window element 202 of FIG. 2A. In this example, the authorized user has entered in “Server room” for the name field of the clause and “Server room only for IT managers & execs” for the description field of the clause. Accordingly, in some embodiments, a clause may comprise one or more fields that may provide context, for example, by giving a clause a name, a description and/or any other context. In some embodiments, a clause may comprise a field for the language of the clause as written in the access policy document. The authorized user can interact with one or more of the interface elements 212, 214, 216, 218 to add conditions to the clause. The authorized user may select the add interface element 212 to first add a first condition to the clause.

In this example, the first condition is an entity. An entity may be classified as a premises-based entity, a person-based entity, or a time-based entity. A premises-based entity is indicative of one or more premises elements of the secured premises 102. The premises elements may include any one or more of the following: one or more spaces, one or more areas, one or more doors, one or more access points, one or more floors, one or more buildings, one or more facilities, one or more workspaces, one or more factories, one or more structures, one or more barriers, and/or any other suitable space, area, location, and/or place. A person-based entity is indicative of one or more persons that may access (or attempt to access) the secured premises 102. The one or more persons may include any one or more of the following: one or more people, one or more groups of one or more people, one or more users, one or more groups of one or more users, one or more cardholders, one or more groups of one or more cardholders, and/or any other suitable grouping indicative of one or more people that may be present at the secured premises 102. A time-based entity is indicative of one or more date and/or time parameters.

In this example, the authorized user selects a “Server Room” entity that corresponds to the area of the secured premises 102 where the servers are located. In this example, the “Server Room” entity is classified as a premise-based entity and is a predefined group that identifies the doors to the server room of the secured premises 102.

In some cases, an entity desirable by the authorized user may not yet be defined, and the authorized user may create a new entity. In some embodiments, the user may be directed to a map and/or floor plan. The authorized user may select one or more areas on the map or floor plan to select one or more premises elements, where the selected areas correspond to one or more doors and/or access points, for example. The authorized user may select one or more spaces, one or more floors, one or more buildings, one or more facilities, one or more workspaces, one or more factories, one or more structures, one or more barriers from the map or floor plan to select the premises elements. The created entity then identifies the selected premises elements, for example.

As the first condition is the “Server Room” entity, in this example, this indicates that this first clause pertains to the server room. The authorized user can then continue to create the first clause by placing further limitations, restrictions or constraints on this clause that pertains to the server room. A connector between conditions and/or a constraint on the conditions may then be added. In this example, the authorized user then selects the constraint interface element 218 to add a first constraint. The first constraint is “Only accessible by”, in this example, to specify that the server room is only accessibly by a following entity or entities. The user then selects the add interface element 212 to add the “IT Managers” entity, selects the grouping interface element 216 and selects the “OR” logical operator, and selects the add interface element 212 to add the “Executives” entity. The second condition, in this example, corresponds to the first constraint of “Only accessible by” and the logical OR operator grouping the “IT Managers” entity with the Executives” entity. In this example, the “IT Managers” entity, is a predefined entity that corresponds to the IT managers that have access to the secured premises 102, and the “Executives” entity, is a predefined entity that corresponds to the executives that have access to the secured premises 102. Accordingly, this first clause specifies that the server room is only accessible by IT managers or executives.

Each entity may identify that with which it is indicative of and may include a set of one or more identifiers. For example, the “Server Room” entity may include a set of identifiers for the doors to the server room, the “Executives” entity may include a set of user identifiers for the executives, and the “IT Managers” entity may include a set of user identifiers for the IT managers. The user identifiers may correspond to those in user records of the user information 108 in the database(s) 114. The door identifiers may correspond to those in door records of the premises information 109 in the database(s) 114. In general, a premises-based entity may include one or more access point identifiers, which may include one or more door identifiers, for example, and which may be stored in the premises information 109. A person-based entity may include identifiers of one or more users, which may be stored in the user information 108.

The authorized user may then add an action, such as a compensatory action, to the clause. The authorized user may interact with the interface elements 222, 224, 226, 228 to add the compensatory action. As illustrated, the action field 220 specifies that the action is for an alarm that is to occur when the conditions of the clause are violated.

This process of creating a new clause may be repeated until all entries in the policy document have been entered into the access policy 104. With additional reference to FIGS. 2C to 2F, second, third, fourth and fifth examples 202(2), 202(3), 202(4), and 202(5) of clauses are shown. Each of these example clauses may be created in a similar manner to the process explained in relation to FIG. 2B. FIG. 2C illustrates a second clause for the second entry (2) in the policy document that specifies “VIP visitors must be escorted by an executive when visiting showrooms”. FIG. 2D illustrates a third clause for the third entry (3) in the policy document that specifies “executives always have access to all doors”. FIG. 2E illustrates a fourth clause for the fourth entry (4) in the policy document that specifies “manufacturing floor employees have access to the manufacturing floor doors and entrance doors during operating hours of Monday to Friday, 7AM to 7PM, and not on holidays”. FIG. 2F, illustrates a fifth clause for the fifth entry (5) in the policy document that specifies “non-managers and non-executives cannot have access during a lockdown period of each day between 11PM and 5AM”.

Each clause of the access policy 104 may comprises at least one condition. Each clause of the access policy 104 may comprises a plurality of conditions. Each clause of the access policy 104 may include a primary condition corresponding to an entity, and one or more ancillary conditions that further specify and/or constrain the primary condition. For example, in FIG. 2C, the clause comprises a primary condition corresponds to a “VIP visitors” entity and two further conditions of: (i) access to a “Showroom” entity, and (ii) when with an “Executives” entity. Each ancillary condition may further constrain the primary condition, as the first ancillary condition specifies that VIP visitors have access to a showroom, and the second ancillary conditions restricts the access to the showroom by the VIP visitors to when they are with executives. It should be appreciated that by creating the clause of the access policy 104 in this manner, that the clauses may be create to more closely mirror the language used in the policy document, and that the clauses may be able to cover entries of the policy document that cannot not be covered by access rules, for example.

The constraints on the conditions may vary, which, for example, may be based on entity type, the selected entity and/or on implementation. For example, constraints may include “accessibly by”, “only accessibly by”, “not accessibly by”, “access to”, “access only to” “no access to”, “when with”, “when”, or any other suitable constraint. The constraint “accessibly by” may be used to specify that a premise-based entity (or group thereof) is accessibly by a person-based entity (or group thereof). The constraint “only accessibly by” may be used to specify that a premise-based entity (or group thereof) is only accessibly by a person-based entity (or group thereof) and cannot be accessible by others. The constraint “not accessibly by” may be used to specify that a premise-based entity (or group thereof) is not accessibly by a person-based entity (or group thereof). The constraint “access to” may be used to specify that a person-based entity (or group thereof) has access to a premises-based entity (or group thereof). The constraint “access only to” may be used to specify that a person-based entity (or group thereof) only has access to a premises-based entity (or group thereof). The constraint “no access to” may be used to specify that a person-based entity (or group thereof) does not have access to a premises-based entity (or group thereof). The constraint “when with” may be used to specify that a person-based entity (or group thereof) has access when with another person-based entity (or group thereof). The constraint “when” may be used to add a day and/or time constraints, which may include one more day and/or time parameters. The constraints may vary depending on implementation. In some embodiments, the authorized user may be able to define any other suitable constraints. The at least one condition of each clause may vary depending on practical implementation.

In some cases, the authorized user may add a “when” constraint to limit the conditions of a clause of the access policy 104, such as in the illustrated example of FIG. 2E. In general, the authorized user may add a date coverage and/or a time coverage to a clause To add a date coverage, the authorized users may select one or more days of the week (i.e., select one or more of Monday, Tuesday, Wednesday, Thursday, Friday, Saturday, and Sunday), select one or more weeks, select one or more recurring dates, or one or more specific dates, for example, from a calendar. To add a time coverage, the authorized users may, for example, select all day or specific time ranges. In the example of FIG. 2E, the authorized user may set a date coverage of Monday to Friday and a time coverage of 8:00 am to 6:00 pm to indicate operating hours. In some embodiments, the authorized user may select or create a time-based entity. The time-based entity may be referred to as a schedule. Rather that entering Monday to Friday for the date coverage and 8:00 am to 6:00 pm for the time coverage, the authorized user may select or create the time-based entity “Operating Hours”. The “Operating Hours” entity comprises parameters for Monday to Friday for the date, 8:00 am to 6:00 pm for the time, and additionally includes parameters that excludes statutory holidays and other office closure days.

Each clause in the access policy 104 may comprise at least one corresponding compensatory action that is to be taken if a given policy is violated. The authorized user may select or enter the compensatory action, for example, based on the policy document, as it may indicate the compensatory action or may select or enter the compensatory action based on other policy or judgement. For example, there may be a list of preconfigured compensatory actions that the authorized user can select therefrom to assign a corresponding compensatory action to a given clause. The compensatory action could be to modify an access rule (e.g., as illustrated in FIG. 2F), to create an alert, to trigger an alarm (e.g., as illustrated in FIG. 2B), to request security personnel proceed to the vicinity of the access point corresponding to the access event (e.g., as illustrated in FIG. 2C), to prompt video to be displayed on the computing device 160 showing the access event, to add the policy violation and/or access event as one or more items in a report that is to later be generated (e.g., as illustrated in FIG. 2E), or any other suitable compensatory action. The compensatory action may include proposing a hardware upgrade when a clause cannot be implemented as a rule in the existing access control equipment 120 (e.g., the door controller 122). The compensatory action may include escalating the access control decision to an access control device capable of implementing a clause as a rule when the existing access control equipment 120 (e.g., the door controller 122) cannot implement the clause as a rule.

The compensatory action information 115 stored in the database(s) 114 may be used to select an existing compensatory action when creating the access policy 104. For example, the compensatory action information 115 may comprise a database table for storing compensatory action information, which may include for each action entry in the table: an action identifier (e.g., an action name), and a corresponding action. The action table may comprise any other suitable information (e.g., information on where a compensatory action is to be transmitted, information on where a compensatory action is to be stored, etc.). Accordingly, the authorized user may be able to select pre-existing actions from the database(s) 114 (or create a new action and store it to the database 114(s)) while creating a clause that is to be added to the access policy 104.

The GUI 200 and the window element 202 may may vary from the examples provided herein. The GUI 200 and the window element 202 may vary depending on practical implementation, as there are many different ways that GUIs can be designed to allow an authorized user to create an access policy, such as the access policy 104.

In general, the access policy 104 may be any suitable grouping of data indicative of one or more clauses for specifying the conditions for access to the secured premises 102. For example, the access policy 104 may include one or more of the following: one or more data structures, one or more database tables, one or more data objects, one or more records, where the data structure(s), database table(s), data object(s) and/or record(s) may reference data in one or more other data structures, databases tables, data objects and/or records.

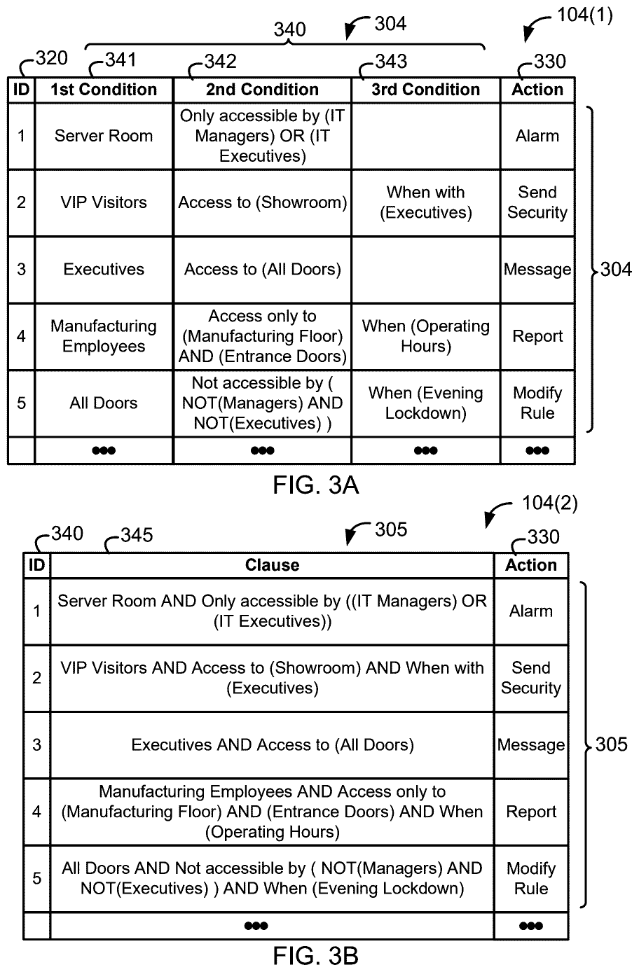

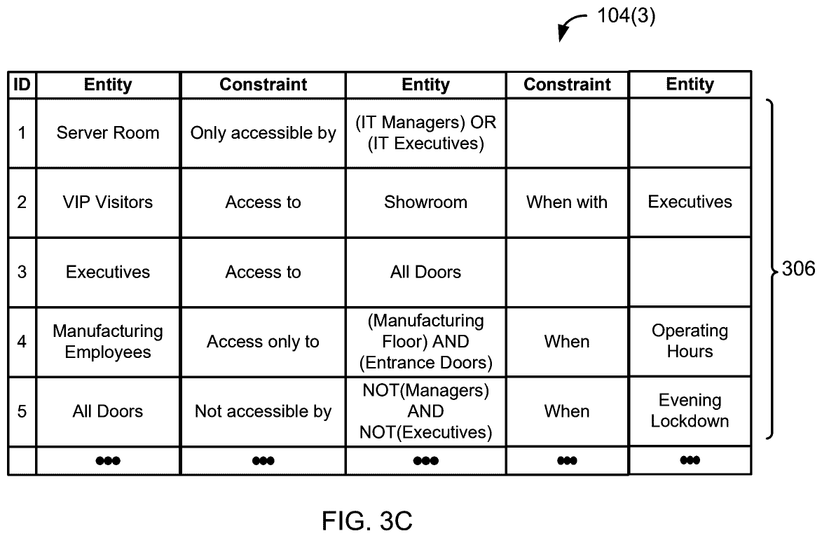

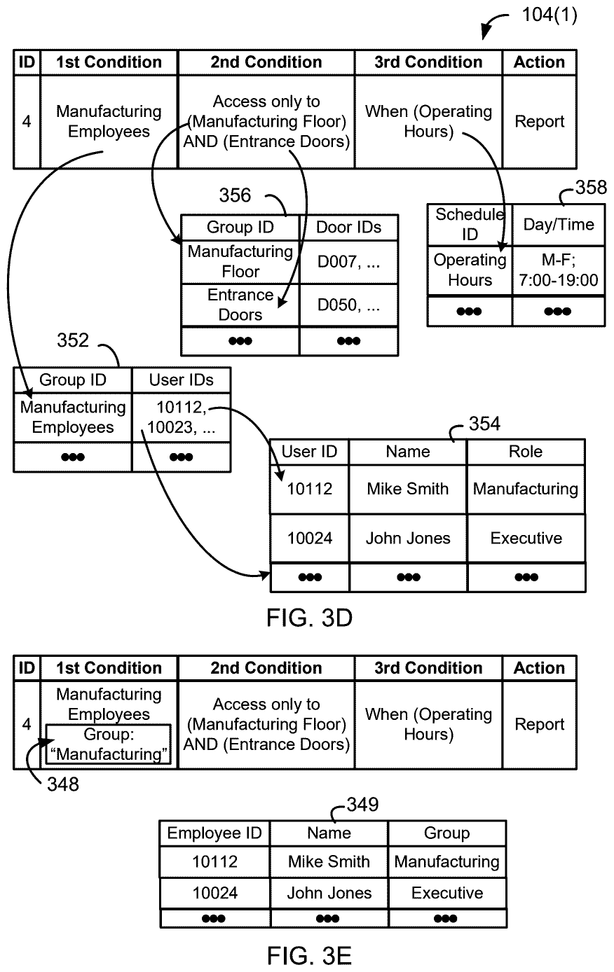

With additional reference to FIG. 3A, there is illustrated a first example of the access policy 104, which is referred to herein as the access policy 104(1). In this example, the rows of the access policy 104(1) corresponds to the clauses 304 of the access policy 104(1) and each column of the access policy 104(1) corresponds to conditions and/or fields. In this example, each clause 304 has a clause identifier field 340, a plurality of conditions 340 (for example, a first condition 341, a second condition 342, and a third condition 343) and an action field 330. The clause identifiers may be automatically generated as the authorized user defines a clause. In some embodiments, the clause identifiers may be specified by the user in the GUI, for example, by entering it into a clause number text box. While sequential clause identifiers are shown, the clause numbers may be non-sequential numbering. While three possible conditions 341, 342, and 343 are shown, in some embodiments, there may be more than three conditions or less than three conditions. As illustrated, clauses 1 to 5 of the access policy 104(1) correspond to the first (1) to fifth (5) entries in the policy document and correspond to the examples shown in FIGS. 2B to 2F. In FIG. 3A, each clause 304 of the access policy 104(1) includes the action field 330; however, in some embodiments the action field 330 may be omitted from the access policy 104(1). The labels “ID”, “1^{st} Condition”, “2^{nd} Condition”, “3^{rd} Condition” and “Action”, are mere example labels, and may vary. In some embodiments, each clause 304 of the access policy 104(1) may include a clause name field and/or a clause description field and, in this example, have been omitted for the sake of brevity. In other words, a clause 304 of the access policy 104 may comprise one or more context fields for provide context to the clause.

While in the example access policy 104(1) of FIG. 3A, each of the conditions 340 is a separate column entry, in some embodiments, the conditions may be combined in forming each clause. With additional reference to FIG. 3B, there is illustrated a second example of the access policy 104, which is generally referred to herein as the access policy 104(2). The second example access policy 104(2) is similar to the first example access policy 104(2); however, each of the clauses 305 comprises a single clause, as shown by the clause field 345. In this example, each of the clauses 305 comprises the conditions connected with the logical “AND” operator.

With additional reference to FIG. 3C, there is illustrated a third example of the access policy 104, which is referred to as the access policy 104(3). The third example access policy 104(3) is similar to the first example access policy 104(1); however, each of the clauses 306 has the entities and the constraints divided into separate columns. The example access policies 104(1), 104(2), 104(3) are only examples of how the access policy 104 may be represented, and other representations are contemplated.

By way of another example, the access policy 104 may be similar to the first example access policy 104(1), but rather than each clause having an action, each clause comprises a corresponding level associated therewith, such as a security threat level field that is indicative of a level of a security threat if the particular clause is violated or an enforcement level. Each level may correspond to an action to be taken. When adding a clause, the authorized user may select or enter the level. Each level may have a respective compensatory action associated therewith and that is to be taken if the clause associated with a given level is violated. For example, there may be a list of levels that the authorized user can select therefrom to assign a corresponding level to a given clause. The authorized user may select or enter the level based on the policy document, as it may indicate the levels or may select or enter the levels based on other policy or judgement.

In some embodiments, the access policy 104 may reference other data and/or data sources. For example, the authorized user, when selecting a person-based entity for a clause, may be selecting pre-existing users and/or user groups from the user information 108 in the database 114, and which may also be used in implementing the access rules 106. In some cases, the authorized user, may create a new person-based entity for a clause, and add users and/or user groups to the person-based entity. The user information 108 may include user information for employees, visitors, contractors, other users, and/or groups of employees, visitors, contractors, and/or any other group of users. The user information 108 may include cardholder information and corresponding credentials, cardholder groups, or any other suitable information.

With reference to FIG. 3D, a specific and non-limiting example of the clause pertaining to manufacturing employees from the access policy 104(1) of FIG. 3A is shown to be referencing another data source. In this example, the “Manufacturing Employees” entity corresponds to a user group of “Manufacturing Employees” in a user group database table 352. For example, the authorized user when selecting the “Manufacturing Employees” entity when creating the access policy 104(1), for example, may access the user information 108 stored in the database 114. The user information 108 may be used to select the users and/or user groups when creating the access policy 104(1). For example, the “Manufacturing Employees” group may have been previously defined when setting up the access rules 106, and the authorized user when creating the access policy 104 may select this group as an entity. For example, there may be a drop-down menu listing different groups of employees that can be selected by the authorized user. In this example, the authorized user selects the existing “Manufacturing Employees” group from the drop-down menu, which references the user group database table 352. The user information 108 may comprise the user group database table 352, and, in this example, includes for each user group entry in the table 352: a user group identifier (e.g., a user group name) and a listing of one or more user identifiers that refer to one or more users in a user database table 354. The user group database table 352 may comprise any other suitable information. The user information 108 may comprise the user database table 354. The user database table 354, in this example, includes for each user entry: a user identifier, a user's name, a user's role. The user database table 354 may comprise any other suitable user information (e.g., a user's title, a user's group, a user's email, etc.).

In some embodiments, the schedule information 111 in the database 114 may be used when adding a time-based entity to a clause of the access policy 104. For example, the schedule information 111 may comprise a schedule table 358 that includes for each schedule entry in the table 358: a schedule identifier (e.g., a schedule name), and day constraint(s) and/or time constraint(s). The schedule table 358 may comprise any other suitable information. Accordingly, the authorized user may be able to select pre-existing schedules from the database(s) 114 (or create a new schedule and store it to the database(s) 114) while creating a clause that is to be added to the access policy 104(1). In the example of FIG. 3D, the authorized user selects the Operating Hours schedule for the “Operating Hours” entity.

In some embodiments, the authorized user, when selecting a premises-based entity for a clause, may be selecting a pre-existing access point and/or access point group from the premises information 109 in the database 114, and which may also be used in implementing the access rules 106. For example, the authorized user may select an access point group called “manufacturing floor doors”, which identifies the doors to the manufacturing floor. In some embodiments, the authorized user may select an area on a map that is associated therewith one or more access points including one or more doors, which may be used to create a new premise-based entity and/or access point group. In some embodiments, the premises information 109 may comprise a door group database table 356 that includes for each entry in the table 356: a door group identifier (e.g., a door group name), and a listing of one or more door identifiers. The door database table 356 may comprise any other suitable user information (e.g., a description of the door, an identifier of the door controller, etc.). Accordingly, the authorized user may be able to select pre-existing access points (e.g., doors) and/or access point groups (e.g., door groups) from the access information while creating a policy that is to be added to the access policy 104(1). In some embodiments, the access policy 104 may be a standalone grouping of data. In other words, in some embodiments, the access policy 104 may not necessarily directly reference another data source.

In some embodiments, the access policy 104 may be implemented independently from the information or data used to implement the access rules 106. For example, while in some cases the access policy 104 may reference the user information 108 used in providing access control to the secured premises 102, in other cases the access policy functions without referring to the user information. In some embodiments, an entity may include a classification of the entity's type. For example, if the entity is a premises-based entity, the classification may specify that this entity type is a premises-based entity. By way of another example, if the entity is a person-based entity, the classification may specify that this entity type is a person-based entity. The entity may include one or more key-value pairs 348 that may be used by the policy validation engine when comparing access events 600 to the clauses of the access policy 104. In a key-value pair, the key is an identifier for a piece of information, and the value is the data associated with the identifier. A key-value pair may be referred to as an attribute. By way of example, a key may specify “Group” or “Cardholder Group” with the value of the key being “Manufacturing”. The value “Manufacturing” may reference an entity or a record that includes identifiers of the manufacturing employees. By way of another example, the key may specify “Manufacturing Employees” and the value may identify the manufacturing employees (e.g., include a list or an array of identifiers of the manufacturing employees or reference an entity or a record that includes identifiers of the manufacturing employees). The key and possible values may correspond to those found in another data source. For example, with reference to FIG. 3E, when the authorized user adds a new clause to the access policy 104(1), the authorized user may select user group names from an HR database (and/or an organization chart). In this example, HR database comprises an employee database table 349 that may be used to obtain the values of different possible employee groups. In some embodiments, the entities include various key-value pairs or labels. For example, “IT managers”, and “Executives” could be other values for the key “Group” and “Server Room” could be a possible value for the key “Location”.

It should be appreciated that the access policy 104 can be configured with clauses having varying context, actions, options, fields, conditions and/or constraints. The access policy 104 may vary from the example access policies 104(1), 104(2) and 104(3), as there are many different ways that data can be arranged to create an access policy, and the access policy 104 may vary depending on practical implementations. The “clauses” of the access policy 104 may be referred as “policies”, “policy clauses”, “sub-policies”; and, similarly, “clause” may be referred to “policy”, “policy clause” or “sub-policy”. The “conditions” may be referred to as “rules”, “rule elements” or “policy rules”, and “condition” may be referred to as “rule”, “rule element” or “policy rule”. The “access policy” may be referred to as a “policy set”, a “policy framework”, a “library of policies” or a “collection of policies”. For example, the access policy 104 may be referred to as a policy framework comprising a plurality of policies, and each of the policies may include one or more policy rules.

In some embodiments, the access policy 104 may be specified in a high-level domain-specific language, for example, such as eXtensible Access Control Markup Language (XACML) or based on Attribute Based Access Control (ABAC). XACML is based on ABAC. In general, ABAC is an attribute-based access control model for deciding who can do what, when, and where. Instead of assigning permissions to static identities or roles, in ABAC, the system may evaluate attributes of the subject, object, action, and environment against the organization's policies. In some embodiments, the access policy 104 may comprises attribute-based expressions. A clause of the access policy 104 may include one or more attribute-based expressions. For example, a condition of a clause of the access policy 104 may include at least one attribute-based expression. In some embodiments, the “entity” may be represented by one or more attributes, for example, when the entity includes or is expressed as one or more key-value pairs (e.g., department=“IT”; clearance-level>3; etc.). One or more attributes may be referred to as an attribute set or a set of attributes. An attribute set may include one or more attribute key-value pairs. The conditions of the clauses of the access policy 104 may include attribute-based expressions that include one or more attribute sets (e.g., user. role IN {IT-manager, “Executive}) in addition to, or instead of, the entity-based conditions. The attributes may be associated with the subject (e.g., person-based entity), the object (e.g., premises-based entity), the action (e.g., “enter”, “exit”, “open”, etc.), and the environment (e.g., time-based entity, location, threat level, etc.). Each entity may include, or correspond to, an attribute set. The attribute set may be stored in any suitable manner, for example, such as in data structures, data objects, records and/or database tables. The attribute sets may be stored as a document-like structure, for example, JavaScript Object Notation (JSON), or JSON-like structure (e.g., {“group”: [“IT-Mangers”, “Executives”], “clearance”: 4}).

In some embodiments, the attribute-based expression is an attribute-conditional rule. The attribute-conditional rule may be considered as a statement that evaluates whether attributes, such as subject attributes, object attributes, action attributes, and/or environmental attributes, meet one or more attribute-based conditions of the attribute-conditional rule. Each condition of the attribute-conditional rule may include an attribute identifier, an attribute operator and an attribute value. The attribute identifier may be any suitable identifier that can be used as a key to match to attributes. The attribute operator may be any suitable relational operator, including: equal to (e.g., “==”), not equal to (e.g., “!=”), greater than (e.g., “>”), greater than or equal to (e.g., “>=”), less than (e.g., “<”), or less than or equal to (e.g., “<=”). The attribute operator may an IN and/or NOT operator to check if a value is in a list and/or not in a list, for example. The attribute operator may be an “includes” or “contains” operator, which may be used to check if an attribute contains a specific element or string. The attribute operator may be an IS operator to check it an attribute is something. The attribute operator may include an intersect operator, for example, to obtain common values in two list. The attribute-conditional rule may be used to sort attributes and/or to select a certain number of sorted attributes. The attribute operator may include an except operator for excluding items. The attribute operator may include an ALL operator to select all items. The attribute operator may include a WITH operator to check if an entity is associated with a particular attribute value, for example. The attribute-conditional rule may include a modifier for modifying one or more conditions of the attribute-conditional rule. The attribute operator may include any other suitable operator. The attribute value may be a string, text, a number, a Boolean value (i.e., true or false, or 1 or 0), an Enum value (i.e., a value from a set of named constraints or known values). The attribute value may be an entity (e.g., a premises-based entity, a person-based entity, or a time-based entity). Each condition of an attribute-conditional rule may include more than one attribute identifier, more than one attribute operator and more than one attribute value, depending on implementation. Multiple conditions of attribute-conditional rules may be expressed in a statement using Boolean operators (also known as logical operators), including: AND, OR, NOT, XOR, or XNOR.

In some embodiments, each clause, or some of the clauses, of the access policy 104 may include an enforcement level. The enforcement level may be selected from a group of pre-defined enforcement levels. The enforcement levels may be referred to as business rule enforcement levels. For example, the pre-defined enforcement levels may include strictly enforced, deferred enforcement, pre-authorized override, post-justified override, override with explanation, and/or guideline. Strictly enforced may refer to if the clause (or rule) is violated, the penalty is always applied. Deferred enforcement may refer to strictly enforced, but enforcement may be delayed. Pre-authorized override may refer to enforced, but exceptions allowed, with prior approval for subjects with before-the-fact override authorization. Post-justified override may refer to if not approved after the fact, may be subject to sanctions or other consequences. Override with explanation may refer to comment must be provided when violation occurs. Guideline may refer to suggested but not enforced. The enforcement level may be specified in the human language policy document and thus may be added to the access policy 104. The enforcement level may indicate the type of compensatory action that is to be taken when a clause is violated.

With reference to FIG. 2G, a specific and non-limiting example 200(6) of a clause with an example attribute-based expression is illustrated. In this example, the GUI allows the user to create an attribute-based expression, and in particular, an attribute-conditional rule. For example, the user may (i) select a pre-defined attribute identifier (e.g., User, Badge, Cardholder, Action, Floor, Door, Time, etc.) from a dropdown list, (ii) specify an attribute operator (e.g., =, !=(i.e., not equals), <, >, IN, NOT IN, CONTAINS, etc.), and (ii) enter or select one or more attribute values, for example, one or more attributes, one or more attribute sets and/or one or more entities (e.g., Manufacturing Employees, Entrance Doors, Operating Hours, etc.). In this example, the GUI allows the user to select an enforcement level for when the clause is violated. In this example, if the clause is violated, an operator may be prompted to specify in the report why the violation occurred. The example of FIG. 2G illustrates a variant of the example of FIG. 2E to illustrate an example of an attribute-based expression in the at least on condition of a clause of the access policy 104. The clause generated in the example of FIG. 2G may be stored in any suitable manner, which may be similar to any of the examples of FIG. 3A to 3D. For example, the attribute-based expression of FIG. 2G may be stored in the clause field 345 of FIG. 3B and an additional field may be added to the record of FIG. 3B for recording the enforcement level. The attribute-based expression may vary from the provided example depending on implementation.

### Access Rules

The access rules 106 comprise rules used by the access control equipment 120 in controlling access to the secured premises 102. The access rules 106 typically comprise a plurality of rules. In general, each rule of the access rules 106 specifies who has access, when they have access and what they have access thereto. More specifically, each rule of the access rules 106 may comprises a condition for who has access, a condition for when they have access, and a condition for what they have access thereto. The access rules 106 may be specified based on identity based access control (IBAC). IBAC employs mechanisms such as access control lists (ACLs) to capture the identities of those allowed to access the secured spaces. If a subject presents a credential that matches one held in the ACL, the subject is given access to the secured space. The access rules 106 may be specified based on Role-Based Access Control (RBAC) model, which employes pre-defined roles that carry a specified set of privileges associated with them and to which subjects are assigned. For example, a subject assigned the role of “Executive” will have access to different sets of secured spaces and at different times than someone assigned the role of “Manufacturing Employee”. At the point of an access request, the door controller 122 may evaluate the role assigned to the subject requesting access, the particular secured space and any time constraints, when rendering an access control decision.

The authorized user may take the policy document (and/or the access policy 104) and use it to create the access rules 106 that are stored in the database 114. In some cases, the systems, methods, and/or embodiments described in this document may be applied to an access control system already setup with existing access rules. In some cases, a person may take the human language policy document, and then specify the rules that are to be implemented in hardware in another document, which the authorized user may then create the access rules 106 therefrom, which may allow for two different opportunities to introduce errors: (1) if the person that specifies the access rules from the policy document incorrectly specifies one or more access rules; and (2) if the authorized user incorrectly creates one or more rules in the access rules 106.

In general, configuring access rules for access control systems in various manners is known in the art. Nonetheless, some examples of configuring access rules are described in this document, for example, to illustrate some of the possible differences between the access rules 106 and the access policy 104.

The access manager 118 may provide a graphical user interface (GUI) for allowing the authorized user to create the access rules 106. Once the authorized user has requested to create a new set of access rules, for example, by selecting a new access rules user interface element, such as a “new access rules” button, the authorized user may then create a new rule for the new access rules, which in this example is the access rules 106. For example, the authorized user may then add a new rule by selecting a new rule user interface element, such as a “new rule” button. The authorized user may then add the new rule by adding conditions for who has access, when they have access and what they have access thereto.

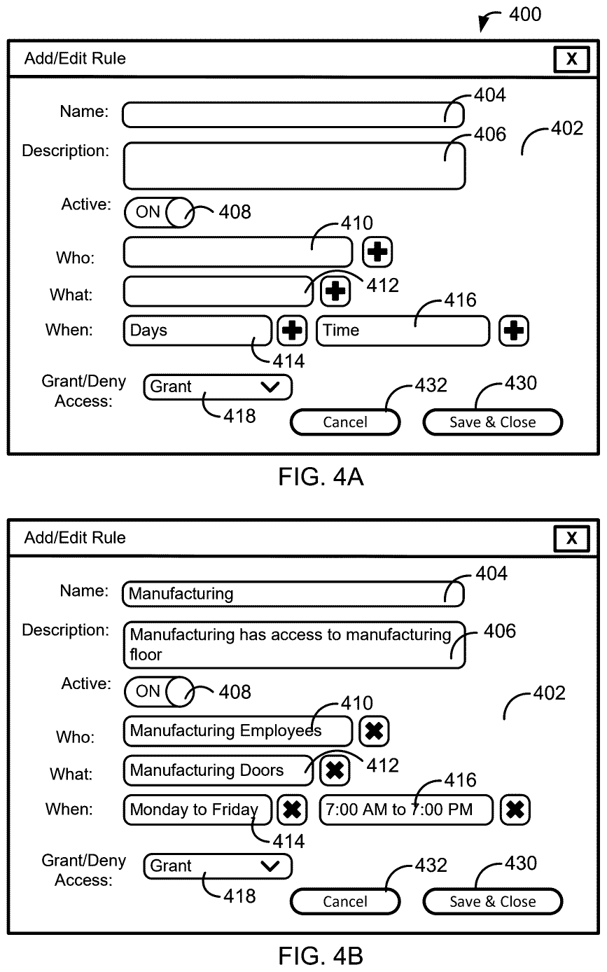

With reference to FIG. 4A, there is illustrated an example of window element 402 of a GUI 400 for adding a new rule to the access rules 106. In this example, the window element 404 includes: a name input box 404 for providing a name to the rule; a description input box 406 for providing a description to the rule; a toggle button 408 to select between “ON” and “OFF” to set the rule as an active rule or disabled rule; a who input box 410 for specifying who has access; a what input box 412 for specifying what they have access to; when input boxes 414, 416 for specify when they have access, and in particular the days and times; a grant or deny selection element 418 to specifying if the rule is for granting access or denying access; a selectable button 430 to save the rule and close the window element 402; and a selectable button 432 to cancel and close the window element 402.

With additional reference to FIG. 4B, there is illustrated an example of a rule created in the window element 402 of FIG. 4A. In this example, the authorized user has entered in “Manufacturing” for name description field 406 and “Manufacturing has access to manufacturing floor” for the description field of the rule. Accordingly, in some embodiments, a rule may comprise one or more fields, and each field of a rule may provide context for the rule. The authorized user can interact with the who input box 410 to add the manufacturing employees, which in this example is a “Manufacturing Employees” group. The authorized user can interact with the what input box 412 to add the manufacturing doors, which in this example is the “Manufacturing Doors” group. The authorized user can interact with the when field boxes 414 and 416 to specify Monday to Friday and from 7:00 am to 7:00 pm.

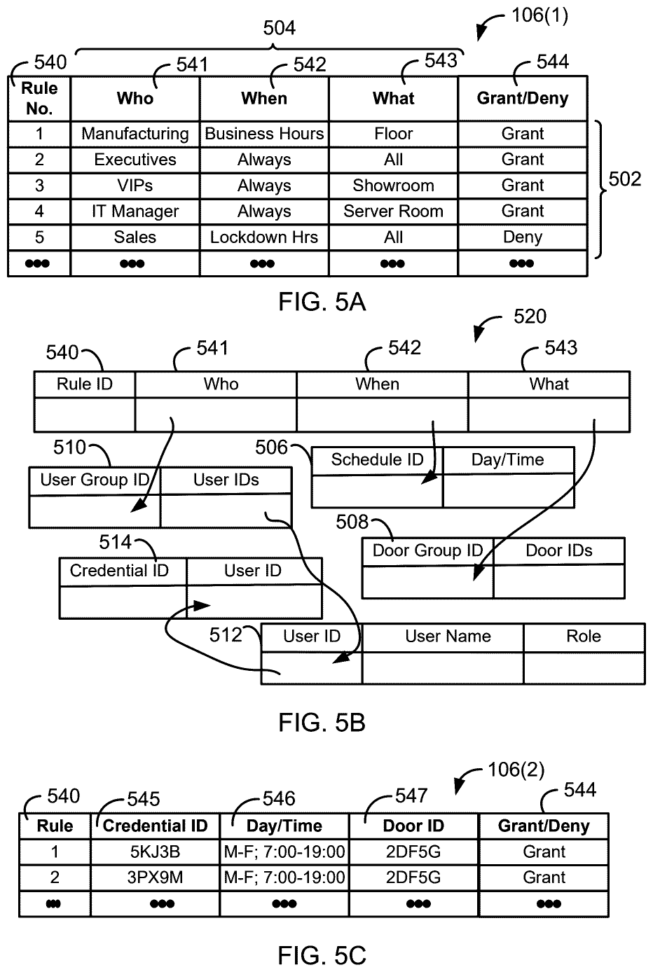

This process of creating a new rule may be repeated until all entries in the policy document have been entered in to create the access rules 106, for example. With additional reference to FIG. 5A, there is illustrated a first example of the access rules 106, generally referred to herein as the access rules 106(1). The access rules 106(1) specify who has access, when they have access and what they have access thereto. The rows of the access rules 106(1) correspond to the rules 502 and each column of the access rules 106(1) corresponds to a respective condition type and/or field type. The authorized user may create the access rules 106(1) by defining the “Who”, “When”, and “What” conditions 541, 542, 543. The grant/deny field 544 specifies if a particular access rule is for granting or denying access. The rule number field 540 may comprise an identifier for each rule. The labels “Rule No.”, “Who”, “When” and “What” are merely labels and may vary depending on practical implementation. For example, the “who” label could be “people”, “users”, “user groups”, “users and user groups” or any other suitable label. The “when” label could be “time”, “time constraints”, “time & date”, or any other suitable label. The “what” label could be “where”, “access point”, “access point group”, “entities”, “associated entities”, “doors”, “areas” or any other suitable label. The “rule no.” label could be “rule number”, “rule id”, “rule identifier”, or any other suitable label. While sequential rule numbers are shown, the rule numbers may be non-sequential numbering.

Referring back to FIG. 4B, in adding to the “who” input box 410 when creating a new rule, the authorized user may select an existing user group or create a new user group. In adding to the “when” input boxes 414, 416, the authorized user may add a date coverage (e.g., daily, weekly, recurring dates, or specific dates) and/or a time coverage (e.g., all day, or specific time ranges). In some embodiments, the adding of the date and/or time coverage may include selecting a schedule. In adding to the “what” input box 412, the authorized user may select an existing access point or access point group or create a new access point group and add access points to the newly created access point group.

The authorized user may configure access control of the secured premises 102 prior to and/or during setting up the access rules 106 and/or access policy 104. The authorized user may configure access control of the secured premises 102 by adding access points and/or groups of access points to the access control computing system 110 and store this information in the database(s) 114 in the premises information 109. For example, the authorized user may add access points, doors, areas, partitions, groups of doors, groups of areas, groups of partitions or any other suitable access point or group thereof. The authorized user may configure the system to add users and/or user groups to the access control computing system 110 and store this information in the database(s) 114 in the user information 108. Each user may be a cardholder that may be represented by a cardholder entity, which represents a person who can enter and exit secured areas by virtue of their credentials, for example access cards, and whose activities may be tracked. The cardholders may be included in the “who” field in an access rule. Cardholders represent people, such as employees, visitors, contractors, or any other suitable person. A cardholder group entity may be used to configure the common access rights and properties of a group of cardholders. To add new cardholder, such as an employee, the authorized user may scan a card that is to be provided to the employee, to obtain the credential of the card and to associate the credentials with the cardholder.

With reference to FIG. 5B, there is illustrated a specific and non-limiting example of database tables for storing the access rules 106(1). A rules database table 520 is shown to include the fields and/or conditions of the access rules 106(1). The rules database table 520 references the database tables 506, 508, 510, which may be stored in the database(s) 114 and/or database(s) 124, in the schedule information 111, the premises information 109, and the user information 108. More specifically, each row entry in the who field 541 may include a user group identifier that references a user group identifier in a user group database table 510 (or may include a user identifier that references a user identifier in a user database table 512). Each row entry in a user identifier field of the user group database table 510 may include one or more user identifiers that reference corresponding user identifiers in the user database table 512. Each row entry in a user identifier field of the user database 510 may include a user identifier, each row entry in a credentials database table 514 may map a user identifier to a user's credential (e.g., a credential assigned to an access card), and a particular user identifier in the user database 510 may be mapped to the same user identifier in the credential database table 514. Each row entry in the when field 542 may include a schedule identifier that references a schedule identifier in a schedule database table 506. Each row entry in a day/time field of the schedule database table 506 may include one or more day and/or time parameters. Each row entry in the what field 543 may include a door group identifier that references a door group identifier in a door database table 508. Each row entry in a door identifier field of the door table 508 may include one or more door identifiers. The door identifiers may be mapped to the access control equipment 120, for example, door controllers 122 and/or readers 126. The rules database table 520 may be processed to generate the access rules 106 in the form suitable for the access control equipment 120, and in particular, for the door controller 122. For example, the access rules 106 may be a list comprising one or more entries, where each entry includes at least one credential, at least one access point identifier (e.g., one or more of: an identifier of a door controller, an identifier of a door, an identifier of a reader, or any other suitable identifier), one or more day and/or time parameters, and an indicator if the rule is for granting or denying access, for example, as is shown in FIG. 5C.

With reference to FIG. 5C, there is illustrated a second example of the access rules 106, herein referred to as the access rules 106(2). The access rules 106(2) specify who has access, when they have access and what they have access thereto. The “who” field lists credentials of cards of cardholders, the “when” field lists the days and times, and the “where” field lists the access point identifiers in the form of door identifiers. The grant/deny field 544 specifies if a particular access rule is for granting or denying access.

The access rules 106 may vary from the example access rules 106(1) and 106(2) provided and may vary depending on practical implementations. The access rules 106 may be a grouping of data, for example, such as data structures, data objects, records and/or database tables, where the data structures, data objects, records, and/or database tables may reference data in other data structures, data objects, records and/or database tables. In some embodiments, the access rules 106 are a list of credentials, identifiers of access points, day and/or time parameters. In some embodiments, there may be additional fields, such as an activation date and/or time, and an expiry date and/or time.

### Access Rules & Access Policy

While access rules 106 may be created in similar manner to creating of the access policy 104, the access rules 106 may differ from the access policy 104. For example, the access policy 104 may be specified based on ABAC and the access rules 106 may be specified based on IBAC and/or RBAC. In some embodiments, the access rules 106 include non-attribute-based rules and the access policy includes clauses based on attribute-based expressions. In some cases, the implemented access rules 106 do not necessarily correspond to the access policy 104 because of human error or equipment faults or limitations. For instance, the authorized user implementing the access rules 106 could make a mistake when adding a cardholder or in creating the access rules or groups, even if the intention is to respect the access policy 104, leading to a critical mismatch between the access policy 104 and the access rules 106. In other cases, the access control equipment 120, such as the door controller 122, may have bugs that allow for contravening access rules.

In some cases, due to hardware limitations and/or other limitations, an authorized user might not be able to add every access rule to the access rules 106 in the same manner as how every clause was added to the access policy 104. For example, as illustrated in FIG. 5A, rule number 3 is supposed to correspond to with policy entry (2) of the policy document which specifies that “VIP visitors must be escorted by an executive when visiting showrooms”; however, according to implemented rule number 3, the VIP visitors always have access to the showroom, as the authorized user was unable to add a constraint that the VIP visitors need to be with executives when on the showroom floor.

By way of another example, the access rules 106 may define conditions specific to who has access, what they have access to and when they have access; and in contrast, the access policy 104 may have multiple conditions, where a first condition corresponds to an entity, for example, a premise-based entity or a person-based entity, and any further conditions may place additional constraints on the first condition. As such, the access policy 104 may be able to mirror more closely the language written in the policy document and/or may be able to include clauses having more complex structure than the access rules 106.

For example, the entry (5) in the policy document specifies that “non-managers and non-executives cannot have access during a lockdown period of each day between 11PM and 5AM”, and FIG. 2F illustrates an example of how this policy may be implemented with “NOT” constraints used in combination with the person-based entities of “Managers” and “Executives” to indicate that if a user is not in those groups, they should not have access to the doors during the evening lockdown period. When the authorized user goes to implement entry (5) into the access rules 106, they may have to add multiple rules, for example, by creating a rule for all the different users or user groups. For example, rule number 5 in FIG. 5A illustrates an example of only one user group, the “Sales” group, which the authorized user has implemented based on entry (3) of the policy document, and the authorized user may have to repeat this process for all the different user groups.

The access policy 104 may be based on the policy document and the access rules 106 may similarly be based on the policy document. In some embodiments, the access rules 106 may be said to be based on the access policy 104, as, for example, the policy document may be used to implement both the access rules 106 and the access policy 104. In some embodiments, the access policy 104 may include clauses which may be used to create the access rules 106 that the access control equipment 120 uses in physically controlling access to the secured premises 102.

In some embodiments, the access rules 106 may correspond to the access policy 104 with the access rules 106 having one or more discrepancies from the access policy 104. The one or more discrepancies may include one or more unknown discrepancies and/or one or more known discrepancies. An unknown discrepancy is a difference between the access policy 104 and the access rules 106 that is unknown, for example, to an authorized user (e.g. an IT professional, a system administrator, etc.), which may occur because of human error in implementing the access rules 106. A known discrepancy is a difference between the access policy 104 and the access rules 106 that is known, for example, to the authorized user such as when there are hardware limitations that prevent the creation of certain access rules.

In some embodiments, the access policy 104 is equipment agnostic, whereas the access rules 106 are rules that apply to the access control equipment 120. For example, as shown in FIG. 5C, the access rules 106 are specifically associated with different door identifiers of the doors with door locks of the access control equipment 120. The access policy 104 may comprise one or more clauses that cannot be tied to the access control equipment 120, and the access control equipment 120 cannot be relied on to ensure that these clauses are followed. Accordingly, in some embodiments, the access policy 104 comprises one or more clauses that cannot be implemented with the access control equipment 120. More specifically, the access policy 104 may comprise one or more clauses that cannot be implemented in the access rules 106.

It should be appreciated that the access policy 104, in some embodiments, can be created such that it more readily corresponds to the vernacular of the policy document, which may not be possible to implement with the access rules 106.

By way of another example, the access rules 106 may define conditions specific to who has access, what they have access to and when they have access; and in contrast, the access policy 104 may be based on attribute-based expressions such as attribute-conditional rules that are evaluated based on attributes, such as such as subject attributes, object attributes, action attributes, and/or environmental attributes. As such, the access policy 104 may be able to mirror more closely the language written in the policy document and/or may be able to include clauses having more complex structure than the access rules 106.

### Access Event

With reference to FIG. 1, the access control equipment 120 may transmit access events 600, such as the access event 600(i), to the access control computing system 110. In particular, the door controller 122 may transmit the access events 600 to the access control computing system 110. Each one of the access events 600 may comprise data indicative of an event occurring at an access point. Each one of the access events 600 may be any suitable grouping of data, for example, such as a data structure, data object, or a record added to a database table in a database. Each one of the access events 600 may include one or more of the following: a timestamp for a time of the access event, a user identifier of a user requesting access (e.g., a user identifier, a cardholder identifier, and/or a credential identifier), an access control decision for the access request (e.g., access granted or access denied), at least one access point identifier associated with the access event (e.g., one or more of: a door identifier, a door controller identifier, a reader identifier, etc.), an identifier of an access rule (e.g., an access rule identifier, a rule number, etc.), a controller identifier (e.g., a door controller identifier of the door controller 122 connected to the reader 126), a reader identifier (e.g., an identifier of the reader 126 that provides a request to the door controller 122 for access), and/or any other suitable information.

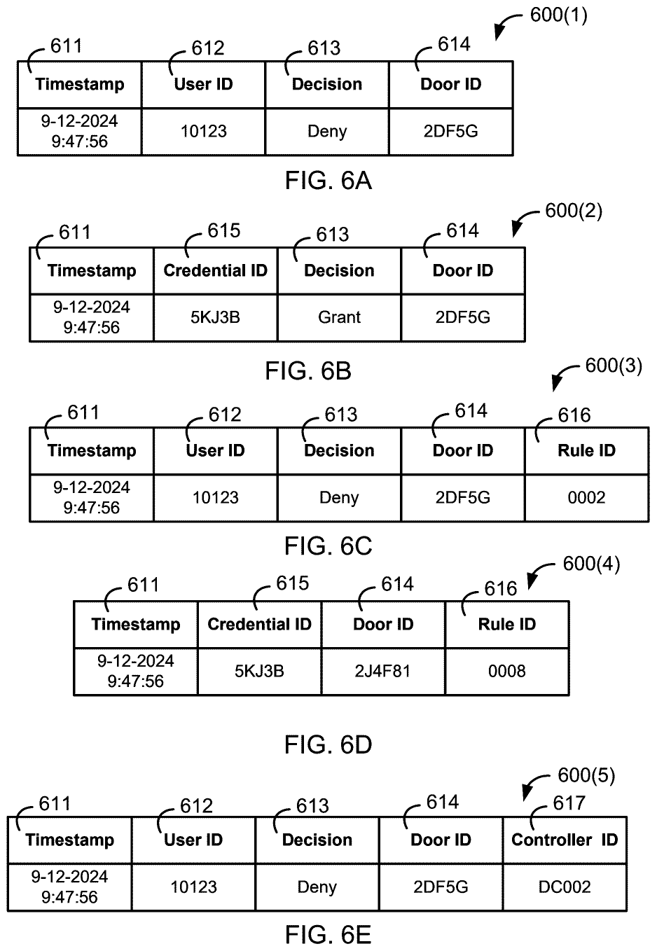

With reference to FIG. 6A, there is shown a first example access event 600(1) illustrating a possible formatting for the access events 600. As illustrated, the access event 600(1), includes a timestamp 611, a user identifier 612, an access control decision 613, which in this example is a deny access decision, an access point identifier 614, which in this example is a door identifier.

With reference to FIG. 6B, there is shown a second example access event 600(2) illustrating a possible formatting for the access events 600. The second example access event 600(2) is similar to the first example access event 600(1), and includes a timestamp 611, a user identifier, which in this example is a credential identifier 615, an access control decision 613, which in this example is a grant access decision, an access point identifier 614, which in this example is a door identifier.

In some embodiments, the access events 600 may include an identifier of the access rule used to make the access control decision. With reference to FIG. 6C, there is shown a third example access event 600(3) illustrating a possible formatting for the access events 600. The third example access event 600(3) is similar to the first example access event 600(1), and additionally includes an access rule identifier 616.

In some embodiments, each access event may correspond to access grant decisions, and the access decision field may be omitted. With reference to FIG. 6D, there is shown a fourth example access event 600(4) illustrating a possible formatting for the access events 600. The fourth example access event 600(4) is similar to the first example access event 600(1) and has omitted the access decision field 613. Accordingly, in some embodiments, each access control event may include a timestamp, a user identifier, an access control decision, an access point identifier, and optionally, an identifier of the access rule used to make the access control decision.

In some embodiments, each access event 600 may include an identifier of the door controller 122 that generated the access event 600. With reference to FIG. 6E, there is shown a fifth example access event 600(5) illustrating a possible formatting for the access events 600. The fifth example access event 600(5) is similar to the first example access event 600(1), and additionally includes a door controller identifier 617.

In the examples of FIGS. 6A to 6E, a door identifier is provided in the access events 600(1), 600(2), 600(3), 600(4), and 600(5); however, in other embodiments, a reader identifier of the reader may be provided alternatively or additionally thereto. In some embodiments, any of the access events 600(i), 600(1), 600(2), 600(3), 600(4), and/or 600(5) may include an indication of the requested operation, for example, an “entry” or an “exit” through the door of the access point. In some embodiments, any of the access events 600(i), 600(1), 600(2), 600(3), 600(4), and/or 600(5) may include an authentication method used, for example, badge, badge only, badge and pin, badge and fingerprint, mobile application, and/or any other suitable indicator of the authentication method used. The data included in the access events 600 may be referred to as parameters. In some embodiments, any of the access events 600(i), 600(1), 600(2), 600(3), 600(4), and/or 600(5) may include multiple timestamps, for example, a timestamp indicative of a time of the access request and a timestamp indicative of a time of the access decision. Any other suitable information may be included in the access events 600(i), 600(1), 600(2), 600(3), 600(4), and 600(5). The access events 600 may vary from the examples provided and may vary depending on practical implementations.

### Policy Validation Engine

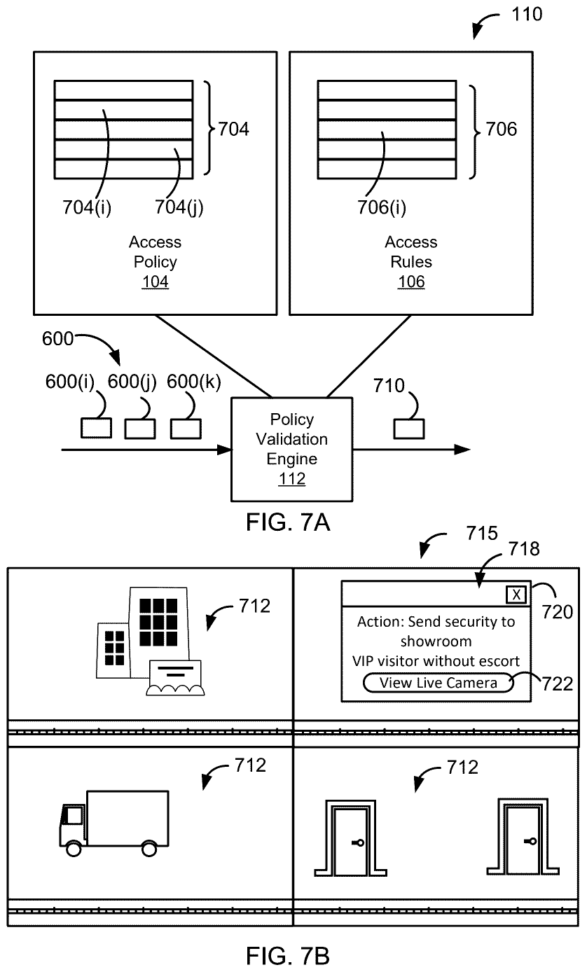

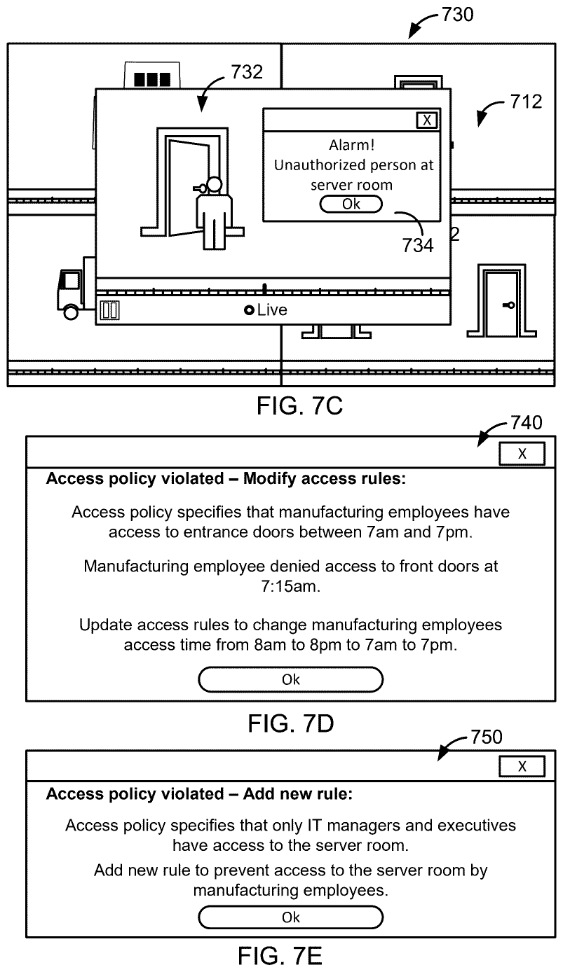

With reference to FIG. 7A, there is illustrated an example for explaining the processing by the policy validation engine 112. The policy validation engine 112 receives access events 600. In the illustrated example, the access events 600 comprise a first access event 600(i), a second access event 600(j), and a third access event 600(k); however, the number of access events 600 may vary. Each one of the access events 600 is processed on receipt by the policy validation engine 112. Each one of the access events 600 may be compared to the access policy 104 comprising a plurality of clauses 704. The policy validation engine 112 may be configured to detect that a particular access event (e.g., access event 600(i)) violate the access policy 104 and to generate a compensatory action item 710 for a compensatory action that is to be taken in response to the particular access event 600(i) violating the access policy 104. In some embodiments, multiple compensatory action items may be generated. The compensatory action item 710, for example, may include one or more of a request to modify the access rule, create a new access rule, an alert, triggering of an alarm, requesting security personnel proceed to the vicinity of the access point, prompting video correspond to the access event to be displayed on a security personnel's computing device 160, generating a report, or any other suitable action. The compensatory action item 710 may be transmitted by the access control computing system 110 to the computing device 160 over the network(s) 170 to cause a notification or other actions to be outputted, for example, display of the notification on the display device 165, prompting video to be displayed on the display device 165, outputting an audible alarm on speakers of the computing device 165, displaying a visual alarm on the display device 165, or any other suitable notification and/or action.

The comparing of each one of the access events 600 to the access policy 104 may occur in real-time or near real-time. Any processing and/or reception that occurs in “real-time” or “near real-time” can include any transmission delay, system propagation delay, processing delay and/or any other suitable delay. For example, a given access event 600(j) generated at the door controller 122 may be transmitted to access control computing system 110 for processing in real-time or near real-time to compare the given access event 600(j) to the access policy 104; however, the real-time or near real-time processing includes any processing delay at the door controller 122 after the given access event 600(j) is generated until it is transmitted, any network transmission delay to transmit the given access event 600(j) over the network(s) 170, any system propagation delay at the access control computing system 110 for receiving the given access event 600(j), any processing delay at the access control computing system 110 to compare the given access event 600(j) to the access policy 104 and any other suitable delay.

In some embodiments, comparing each one of the access events 600 to the access policy 104 occurs at a scheduled time. For instance, a batch of one or more access events (e.g., access events 600(j) and 600(k)) may be processed at a scheduled time. The scheduled time may be on a predefined interval (e.g., every few minutes, every hour, every few hours, every day, etc.) or a set time (e.g., one or more times in a day, week, month, etc.). The access events (e.g., access events 600(j) and 600(k)) may be stored in a queue or may be stored in a database table of the database(s) 114 for later processing, for example, when the predefined interval has passed or at the set time.

In some embodiments, each one of the access events 600 may be compared to each one of the clauses 704. In some embodiments, each one of the access events 600 may be compared to at least some of the clauses 704. For example, the access event 600(i) may be compared to a particular clause 704(i) to determine if the access event 600(i) complies with or is in violation of the particular clause 704(i). When the access event 600(i) is detected to violate the particular clause 704(i), the policy validation engine 112 determines that the access policy 104 is violated. The policy validation engine 112 may stop comparing the access event 600(i) to any remaining clauses when it determines that the access policy 104 has been violated. In some embodiments, policy validation engine 112 continues to compare the access event 600(i) to any remaining clauses when it determines that the access policy 104 has been violated by a particular clause 704(i). By way of example, if the particular clause 704(i) specifies that only IT managers and executives have access to a server room, and the particular access event 600(i) has a user identifier corresponding to a manufacturing floor employee (i.e., someone that is not an IT manager or an executive) then the access policy 104 is violated by the particular access event 600(i).

In some embodiments, the policy validation engine 112 processes a particular access event 600(i) by translating the data in the access event 600(i) to a form that can be compared to the access policy 104. For example, the policy validation engine 112 may use the user identifier or the credential identifier in the access event 600(i) and identify one or more user groups having corresponding user group identifiers. Various clauses of the access policy 104 may include identifiers of user groups, which may allow for the policy validation engine 112 to compare the particular access event 600(i) to the access policy 104. By way of another example, the policy validation engine 112 may use the access point identifier in the access event 600(i) and identify access point groups having corresponding access point group identifiers. Various clauses of the access policy 104 may include identifiers of access point groups, which may allow for the policy validation engine 112 to compare the particular access event 600(i) to the access policy 104. In some embodiments, the policy validation engine 112 identifies a subset of clauses of the clauses 704 of the access policy 104 based on a user identifier of the particular access event 600(i) that it is currently processing and processes the subset of clauses to detect if particular access event 600(i) violates the access policy. In some embodiments, the policy validation engine 112 identifies a subset of clauses of the clauses 704 of the access policy 104 based on an access point identifier of the particular access event 600(i) that it is currently processing and processes the subset of clauses to detect if particular access event 600(i) violates the access policy. Accordingly, the policy validation engine 112 may process a particular access event 600(i) to identify one or more applicable clauses of the access policy 704 that apply to the particular access event 600(i) and then determining if the particular access event 600(i) complies with each of the appliable clauses of the access policy 704.

In the example illustrated in FIG. 7A, the access rules 106 comprises a plurality of access rules 706. In some embodiments, the policy validation engine 112 identifies a particular access rule 706(i) that resulted in the access policy 104 being violated by the particular access event 600(i). The policy validation engine 112 may emulate access at an access point corresponding to the particular access event 600(i) to detect the particular access rule 706(i). Depending on implementation, the access events 600 may not include the access rule or an identifier of the access rule 706(i) that led to the decision of the access event 600(i), and as such emulating access at an access point may be performed to detect the particular access rule 706(i).

For example, if the particular access event 600(i) is provided in the format corresponding to the second example access event 600(2) of FIG. 6B, the access point identifier, which in this example is a door identifier 614, is obtained from the access event 600(2) and the policy validation engine 112 may emulate access at this access point. Continuing with this example, the policy validation engine 112 may identify the reader 126 and the door controller 122 corresponding to the door identifier 614 and emulate the functionality of door controller 122 as if the reader 126 had transmitted the request with the user's credentials 615 obtained from the access event 600(2). Then, in this example, using the timestamp 611 obtained from the access event 600(2) and the policy validation engine 112 processes the access rules 106 appliable to the door controller 122 at a time of occurrence of the timestamp 611, with the user's credentials 615, for the door 130 and corresponding reader 126 for the door identifier 614. The policy validation engine 112, then, in this example, identifies the particular access rule 706(i) that resulted in the access control decision at the door controller 122, and thus also identifies the particular access rule 706(i) that violated the access policy 104.

In some embodiments, the policy validation engine 112 may obtain the particular access rule 706(i) from the plurality of access rules 706 using an identifier of the access rule 706(i) obtained from the particular access event 600(i). For example, if the particular access event 600(i) is provided in the format corresponding to the third example access event 600(3) of FIG. 6C, the identifier 616 of the of the access rule 706(i) can be obtained and then compared to access rules 106 to obtain the particular access rule 706(i).

In some embodiments, the identified particular access rule 706(i) is compared to the particular clause 704(i) that is violated by the particular access event 600(i) to determine a recommendation for user modification of the particular access rule 706(i). The recommendation for user modification may be based on a difference between the particular access rule 706(i) and the particular clause 704(i) that is violated by the particular access event 600(i). The particular access rule 706(i) once identified may be compared to the particular clause 704(i) that is violated by the particular access event 600(i) to determine the difference between the particular access rule 706(i) and the particular clause 704(i) that is violated by the particular access event 600(i). The difference may then be included in the compensatory action item 710 to form the recommendation for the user modification of the particular access rule 706(i). The recommended may be to change a parameter, such as one of the conditions and/or fields, of the particular access rule 706(i) from a current value to a new value corresponding to that of the particular clause 704(i) for that parameter based on the identified difference.

The access policy 104 may indicate for each of the clauses 704 the compensatory action that is to be performed, for example, as shown in FIGS. 3A and 3B. Each of the clauses 704 may have a corresponding compensatory action associated therewith. In some embodiments, there may be multiple compensatory actions associated with each of the clauses 704. Each of the clauses 704 may have a security threat level of a plurality of security threat levels associated therewith, and where each security threat level in the plurality has at least one compensatory action associated therewith. The compensatory action item 704 may be generated based on the compensatory action or the threat level indicated in the particular clause 704(i).

In some embodiments, generating the compensatory action item 710 comprises transmitting an alert to the computing device 160 in communication with the access control computing system 110 to cause a notification to be displayed by the computing device 160 on the display device 165 in order to indicate to the authorized user to take a compensatory action. In some embodiments, the notification is to send security personnel to an access point associated with the particular access event 600(i). For example, with additional reference to FIG. 7B, there is illustrated a graphical user interface (GUI) 715 being displayed on the display device 165 of the computing device 160 to show an example of a notification 718 output by the computing device 160 in response to receiving the compensatory action item 710. The GUI 710 comprises a plurality of display windows 712 showing live video. As in this example, the user is monitoring various cameras showing live video surveillance footage for the secured premises 102. The GUI 710 comprises an alert box 720 indicating that a compensatory action is needed, which in this example is send security to the showroom as a VIP visitor is without being escorted by an executive. The alert box 720, in this example, comprises selectable buttons 722, which allow the user to view the live video of where the violation occurred.

In some embodiments, the compensatory action item 710 comprises an alarm to be output by the computing device 165. In some embodiments, the compensatory action item 710 prompts video to be displayed by the computing device 160. For example, with additional reference to FIG. 7C, there is illustrated a GUI 730 being displayed on the display device 165 of the computing device 160 to show an example of a visual alarm 734 output by the computing device 160 in response to receiving the compensatory action item 710. In this example, the GUI 730 comprises a plurality of display windows 712 showing live video, as the user is monitoring various cameras showing live video surveillance footage for the secured premises 102, and a visual alarm in the form of an alert box 734 is superimposed onto the display windows 712. The alert box 734 in this example specifies that an authorized person has entered the server room. Also, in this example, compensatory action item 710 prompts live video 732 to be displayed by the computing device 160. More specifically, in this example, the live video 732 is superimposed over the display windows 712 to show footage of the access point, which in this example is the server room door, where it was detected that the access policy 104 has been violated.

In some embodiments, the compensatory action item 710 comprises a request for user modification of the particular access rule 706(i) that resulted in the access control decision of the particular access event 600(i) that violates the access policy 104. In some embodiments, the compensatory action item 710 further indicates a recommendation for one or more settings of the conditions and/or parameters for the modification to access rules 106 based on the particular clause 704(i) of the access policy 104. For example, as shown in FIG. 7D, an alert box 740 is displayed by the computing device 160 instructing the authorized user to modify the access rules 106. In this example, the alert box 740 indicates: which clause of the access policy 104 has been violated (“Access policy specifies that manufacturing employees have access to entrance doors between 7am and 7pm.”); the specific access event that causes the violation of the access policy 104 (“Manufacturing employee denied access to front doors at 7:15am.”); and a recommendation of how the authorised user could update the access rules 106 (“Update access rules to change manufacturing employees access time from 8am to 8pm to 7am to 7pm.”). In some embodiments, the compensatory action 710 may be a request to remove a particular access rule as it is no longer needed and/or no longer in compliance with the access policy 104.

In some embodiments, the compensatory action item 710 indicates that no corresponding access rule exists for the particular clause 704(i) that was violated by the particular access event 600(i), and which may further indicate to create a new access rule corresponding to the particular clause 704(i) of the access policy 104. In some embodiments, the compensatory action item 710 further indicates a recommendation for one or more settings of the conditions and/or parameters for the new access rule corresponding to the particular clause 704(i) of the access policy 104. For example, as shown in FIG. 7E, an alert box 750 is displayed by the computing device 160 instructing the authorized user to add a new rule, as the access policy specifies that only IT managers and executives have access to the serve room, and that a new rule needs to be added to prevent access to the server room by manufacturing employees.

In some embodiments, the compensatory action item 710 indicates that an access control device may be added into the access control equipment 120 for proposing a hardware upgrade when a clause cannot be implemented as a rule in the existing access control equipment 120 (e.g., the door controller 122). In some embodiments, the compensatory action item 710 indicates that the existing access control equipment 120 (e.g., the door controller 122) be configured such that certain access requests are transmitted to a certain access control device (e.g., a networked appliance and/or a microserver connected to the door controller 122, the access control computing system 110, etc.) for making the access control decision for a clause that cannot be implemented as a rule with the existing access control equipment 120 (e.g., the door controller 122). In some embodiments, the compensatory action item 710 comprises a request for modifying a user's access to a particular space and/or modifying the access control rules 106 to modify a user's access to a particular space.

It should be appreciated that the various embodiments described herein allow for one or more discrepancies between an access policy 104 and implemented access rules 106 at the access control equipment 120 to be addressed by the compensatory action item 710, for example.

In some embodiments, the access policy 104 comprises a particular clause 704(j) that is incompatible with the access control equipment 120 such that the particular clause 704(j) is unsuitable to be implemented as a corresponding rule in access rules 106. Accordingly, detecting that the particular access event 600(i) violates the access policy 104 may comprise detecting that the particular access event 600(i) violates the particular clause 704(j) that is unsuitable to be implemented as a corresponding rule in access rules 106.

By way of a specific and non-limiting example, the policy validation engine 112 receives the access control event 600(k) from the door controller 122. The door controller 122 in this example is at a showroom door. A person, which happens to be a VIP visitor, scans their card 140 at the reader 126. The door controller 122 is implementing the example access rules 106(1) of FIG. 5A, and, in this example, grants the VIP visitor access to the showroom based on rule number 3 of the example access rules 106(1). The door controller 122 generates, in this example, the access event 600(2) of FIG. 6B, which corresponds to the access control event 600(k) in FIG. 7A. The policy validation engine 112, processes the access event 600(2), obtains the credential identifier 615, and compares the credential identifier 615 to the credentials database table 514 of FIG. 5B to obtain a user identifier for the VIP visitor. The user identifier is then compared to the user group table 510 to determine that the VIP visitor belongs to a VIP visitor user group. The policy validation engine 112 then identifies the subset of clauses of the access policy 104 that correspond to VIP visitors, and in this example is clause 2 of access policy 104(1) in FIG. 3A. The policy validation engine 112 then processes access events in a timeframe around the time of occurrence of the access control event 600(k) as indicated in the timestamp 611. The policy validation engine 112 may search past access events that occurred in the timeframe prior to the time of the particular access event 600(k) and may wait for the timeframe to pass to monitor for any incoming access events and determines that clause 2 of the access policy 104(1) has not been met, as there was an absence of any access events from an authorized user that is an executive at the same access point with the door identifier 614 of the access event 600(2). The policy validation engine 112 then generates the compensatory action item 710 in the form of a notification to send security to showroom based on the compensatory action in the action field 330 of the access policy 104(1). FIG. 7B illustrates an example of the notification of the compensatory action that may be displayed in this example.

In some cases, the access control computing system 110 may be configured to implement complex policy at a sally port. A sally port is an access control system that uses a series of interlocking doors, for example, such as a first door and a second door, to create a secure and controlled entryway to a facility. For example, to enter the first door of a sally port, the policy document may specify that the cardholder that opens the first door of the sally port is currently an on-duty employee, the facility is not under lockdown due to an incident, and that the second door is locked; to open the second door, the first door must be closed and locked, the cardholder that opens the second door of the sally port is currently an on-duty employee, and the facility is not under lockdown due to an incident. Accordingly, the access policy 104 may include a clause to check if the employee opening the first door and the second door is currently on-duty, for example, by checking a database that indicates the employees shifts, and check the environmental attributes of facility to confirm it is not under lockdown. In contrast, in this example, the access rules 106 may only check if the employee is of a type that is authorized to open the first door.

In some cases, the access control computing system 110 may be configured to implement complex policy to restrict access to certain spaces for certain periods of time when access is made to a particular space. For example, a facility may include multiple labs, and the policy document may specify that a cardholder that accesses one lab is prohibited from entering any other labs for a certain period of time (e.g., 24 hours). Accordingly, the access policy 104 may include a clause to check if an employee that is entering one lab has accessed another lab in a certain period of time. In contrast, in this example, the access rules 106 may only check if the employee is of a type that is authorized to enter the lab. In some embodiments, the access control computing system 110 may be configured to detect when an employee enters one lab, updates the access rules 106, and transmits the updated access rules to the door controller 122 such that it prohibits the employee that entered the lab from entering any other labs. The access control computing system 110 may be configured to detect when the time period has lapsed and then updates the access rules 106 to re-allow access to the labs, and transmits the updated access rules to the door controller 122 such that the employee can access any of the labs that they would otherwise be authorized to access.

In some cases, the access rules 106 implemented by the access control equipment 120 may have been there for a long time, and the organization's policy could have changed but perhaps the rules aren't correctly or fully changed to reflect the policy change. As such, the embodiments described herein may be used to audit an existing control system with a large number of access rules and then be used to double check that the implemented access rules do not violate the organization's policy document. In some embodiments, the access control computing system 110 may be configured to allow a user to request an audit of the access rules 106 for compliance with the policy document and/or the access policy 104. For example, the access control computing system 110 may allow the user to periodically (e.g., yearly, quarterly, monthly, etc.) input the policy document in a natural language into the access control computing system 110 to be compared to the access policy 104 and/or the access rules 106. The access control computing system 110 may process the policy document in a natural language, for example, by use of a language model, to format the business rules in format suitable for comparison to the access policy 104 and/or the access rules 106. The policy document may be compared to the access policy 104 and/or the access rules 106 to determine if the access policy 104 and/or the access rules 106 is compliant with the policies of the policy document or not. The access rules 106 may be compared to the access policy 104 to determine if the access rules 106 is compliant with the access policy 104 or not. The access control computing system 110 may, generate a list of violation, a list of clause and/or rule updates, such as modifications to current the access policy 104 and/or the access rule 106 and/or adding of additional clauses to the access policy 104 and/or adding of additional rules the access rules 106. The access control computing system 110 may also include in the list of violation the corresponding enforcement level.

In some embodiments, the access control computing system 110 may be configured to detect when any rules of the access rules 106 contradict each other and/or when any clauses of the access policy 104 contradict each other. A rule contribution algorithm may compare rules of the access rules 106 to each other to determine if there is a contradiction between two or more rules. The contradiction may indicate an incompatibility between the two or more rules such that the two or more rules should not be in operation at the same time as they may lead to contradictory results (e.g., one rule granting access and another rule denying access). Rules applicable to the same cardholder and/or access point (or space) may be compared to each other to determine if there is any contradiction applicable to the cardholder and/or access point (or space). When a contradiction is detected between at least two rules, a notification may be generated to indicate the contradiction and the at least two rules, and the notification may be transmitted to the computing device 160 for notifying a user operating the computing device 160. A policy contribution algorithm may compare clauses of the access policy 104 to each other to determine if there is a contradiction between two or more clauses. The contradiction may indicate an incompatibility between the two or more clauses such that the two or more clauses should not be in operation at the same time as they may lead to contradictory results (e.g., one clause allowing access and another clause denying access). Attributes and/or attribute expressions of the clauses may be compared to each other to detect the contradiction. Clauses applicable to the same subject and/or object may be compared to each other to determine if there is any contradiction applicable to the subject and/or object. When a contradiction is detected between at least two clauses, a notification may be generated to indicate the contradiction and the at least two clauses, and the notification may be transmitted to the computing device 160 for notifying a user operating the computing device 160.

In some embodiments, the access policy 104 comprises a plurality of policies, where each policy comprises a plurality of key-value pairs associated therewith. In some embodiments, the policy validation engine 112 processes a given access event to obtain various key-value pairs (e.g., “group”: “manufacturing”; “access point”: “server room”; etc.) and then compares the key-value pairs of the given access event to the clauses of the access policy 104 having various key-value pairs to determine which clauses apply to each access event.

In some embodiments, the policy validation engine 112 may evaluate a particular clause that includes at least one attribute-based expression (e.g., an attribute-conditional rule) by first obtaining attributes corresponding to a particular access event 600(i). The parameters (e.g., timestamp, user identifier, access control decision, access point identifier, etc.) of the particular access event 600(i) may be obtained from the particular access event 600(i) and used to obtain the attributes and/or may include attributes that are used in the evaluation of the attribute-based expression. At least some of the attributes may be obtained by querying one or more data sources with one or more of the parameters, such as querying one or more databases of the access control computing system 110, and/or one or more external data sources (e.g., external databases, application program interfaces (APIs), etc.) separate from the access control computing system 110.

The attributes obtained may include attributes of the subject, such as the attributes of the user or cardholder corresponding to a particular access event 600(i), attributes of the object, such as the attributes of the secured area, door, and/or access point, which the user or cardholder has requested access thereto by a particular access event 600(i), attributes of the environment, such as of the time and/or date of the access request and/or access event 600(i), day of the week, and/or attributes of the action by the subject on the object, such as “enter” or “exit”.

The user identifier of the access event 600(i) may be used to obtain the subject attributes. The subject attributes may include one or more of the following: the user identifier or card identifier (e.g., which may be obtained from the access event), name, date of birth, home address, training record, job title, function and/or role (e.g., which may be obtained for a directory or HR system), security clearance or trust level (e.g., level 1, confidential, top secret, which may be obtained from a security clearance database), employment type (e.g., full-time, contractor, temporary, intern, or the like, which may be obtained from a HR system or payroll database) , shift schedule (e.g., day shift (e.g., 8:00-16:00), night shift (e.g., 20:00-04:00), or the like, which may be obtained from a HR system or workforce management system), a card expiration or valid from date, a group membership (e.g., Building ABC Access, Manufacturing Employees, or the like) and/or any other suitable attribute of the subject.

The access point identifier or identifiers of the access event 600(i) (e.g., the door identifier, the reader identifier, door controller identifier and/or identifier of the space granted or denied access by the access event) may be used to obtain the object attribute. The object attributes may include one or more of the following: the door identifier, the reader identifier, door controller identifier and/or identifier of the space (e.g., which may be obtained from the access event or may be obtained by using one or more identifiers of the access event), a facility or building (e.g., headquarters, warehouse, or the like, which may be obtained from a facility management system), a zone or area type (e.g., public, restricted, confidential, top secret, or the like, which may be obtained from a facility security plan), a required clearance (e.g., level 2, or the like, which may be obtained from a facility security plan), allowed roles or groups (e.g., facilities team, IT operations, or the like), an access schedule (e.g., 08:00-18:00 Mon-Fri, 24×7, or the like, which may be obtained from a door schedule configuration), a maximum occupancy (e.g., 50 persons, which may be obtained from a fire code or building automation system), an equipment type (e.g., card reader, biometric, turnstile, or the like), a maintenance mode (e.g., true or false to indicate if door is disabled for service, which may be obtained from a facility operation system) and/or any other suitable attribute of the object. The object attributes may include any suitable attribute(s) indicative of the access point or a group of access points (e.g., Lobby Doors, Server Room Door, etc.), indicative of the space or a group of spaces (e.g., Lobby, Server Room, Manufacturing Floor, etc.), and/or indicative of the entity (e.g., a premises-based entity) that subject has requested access thereto. For example, a door identifier of a door to a particular space and an indication of entering the particular space, may be used to obtain an attribute of the particular space (e.g., Manufacturing Floor, Showroom, Lobby, etc.).

A timestamp of the access event 600(i) (e.g., which may include the timestamp of the access request and/or a timestamp of the access decision), and/or the access point identifier or identifiers of the access event 600(i) (e.g., the door identifier, the reader identifier, door controller identifier and/or identifier of the space granted or denied access by the access event) may be used to obtain any environment attributes occurring at the time of the access event 600(i) and/or the access request. The environment attributes may include one or more of the following: time and/or date (e.g., which may be obtained from the access event), day of the week (e.g., Monday, Weekend, or the like, which may be derived from the date or timestamp), holiday and/or special event day (e.g., public holiday, company retreat, or the like, which may be obtained from a calendar service), weather and/or temperature (e.g., clear, rain, show, low-light, or the like, which may be obtained from a weather API or building sensors), emergency status or threat level (e.g., fire alarm, active lockdown, none, or the like, which may be obtained from an integrated emergency notification system), a building or area occupancy (e.g., low, full, over capacity, 50, 100 or the like, which may be obtained from occupancy sensors or building system), and/or any other suitable attribute indicative of the environment.

The action attributes may be obtained from the access event 600(i). The action attributes may be directly obtained from the access event 600(i) and/or derived from the parameters of the access event 600(i). The access control decision, the indication of the requested operation (e.g., entry or exit), the indication of the authentication method, and/or the access point identifier or identifiers of the access event 600(i) (e.g., the door identifier, the reader identifier, door controller identifier and/or identifier of the space granted or denied access by the access event) of the access event 600(i) may be used to obtain the action attributes. The action attributes may include: a requested operation (e.g., enter, exit, open, close, tailgate attempt, proximity pass, or the like), an authentication method used (e.g., badge only, badge and pin, badge and finger print, mobile application, or the like), an attempt type (e.g., first attempt, retry, forced entry, or the like) and/or any other suitable attribute indicative of the action.

The obtained attributes associated with the access event 600(i) may then be compared to the access policy 104 to identify one or more clauses of the access policy 104 that are applicable to the access event 600(i). The applicable clauses may include any clauses that matches to one or more of the obtained subject attributes and/or to the one or more of the obtained object attributes. For example, the policy validation engine 112 may identify all of the clauses that pertain to object attribute (e.g., to a particular space, access point, door, etc.) to determine if any of the identified clauses are satisfied or if the identified clauses are violated. In some embodiments, the clause is satisfied only if all attribute-based expressions included in the clause evaluate to a logical true (e.g., when multiple attribute-based expressions are combined with a logical AND). In some embodiments, the clause is satisfied when it evaluates to a logical true (e.g., when logical OR groupings are specified). When a particular clause is violated (i.e., not satisfied), the compensatory action associated with the particular clause may be performed.

By way of a specific and non-limiting example, the policy document may specify that “contractors may only access the loading dock during their scheduled shift, and must present a badge+PIN” and the attribute-based expression may correspond to: “subject.employmentType=“Contractor” AND resource.zone=“Loading-Dock” AND time IN subject.shift AND action.authMethod=“Badge+PIN””; the policy document may also specify that “visitors who have been pre-registered and checked-in may enter the lobby and conference room for the duration of their appointment” and the attribute-based expression may correspond to: “subject.role=“Visitor” AND subject.visitorStatus=“Checked-In” AND resource.zone IN {“Lobby”, “Conference-Room”} AND time≤subject.appointmentEnd”; and the policy document may further specify that “if a door is in maintenance mode, only the facilities team may open it, and only with a badge and biometric” and the attribute-based expression may correspond to: “resource.maintenance=true AND subject.group IN {“Facilities”} AND action.authMethod=“Badge+Biometric””. Accordingly, in this example, the various attributes of the access events 600 may be obtained from different data sources (e.g., shift schedules, HR databases, visitor registration databases, etc.) and then compared to the attribute-based expressions, to determine the applicable clauses to the subject and/or object of the access events 600 and then to determine if any of the attribute-based expressions of the appliable clauses are satisfied and/or violated.

In some embodiments, the access policy 104 comprises a plurality of policies, where each policy includes a policy written in sentence form. The access policy written in sentence form may match those in the policy document. In some embodiments, the policy validation engine 112 processes each policy in the natural language form to detect if the policy is violated. For example, the policy validation engine 112 may process each access event to obtain one or more labels for each of the identifiers (e.g., “manufacturing employee” from the identifier of the user; “server room” from the access point identifier), the policy validation engine 112 may then compare the labels to the policy document written in sentence form to detect any discrepancy. In some embodiments, the policy validation engine 112 may include a language model (e.g., a large language model) or may transmit the access policy 104 and the labels obtained from the access events to the language model (e.g., the large language model), which may determine if an access event complies with the access policy 104 or if any of the clauses of the access policy 104 are violated. The policy validation engine 112 may vary depending on practical implementation. The policy validation engine 112 may be any suitable software and/or program running on the access control computing system 110.

In some embodiments, the policy document may be processed by a language model (e.g., a large language model) to generate the access policy 104 and/or access rules 106. The access control computing system 110 may compile the access rules 106 from the policy document and/or the access policy 104. To compile the access rules 106, the access control computing system 110 may determine the capabilities of the target access control equipment 120. The access control computing system 110 may detect when the capabilities of the target access control equipment 120 is unable to accommodate the policy document and/or the access policy 104 and may generate a notification which is transmitted to the computing device 160 for alerting a user. This may be useful to detect enforcement failure, for example, prior to enforcement of the policy document with the access rules 106.

In some embodiments, the access control computing system 110 may propose a hardware upgrade when a policy is too complex to be implemented by existing access control equipment 120. For example, when the policy validation engine 112 detects that a clause of the access policy 104 has been violated, the access control computing system 110 may determine that the clause was violated because the existing access control equipment 120 is unable to implement the clause, and may propose a hardware upgrade of one or more access control devices, for example, such as a networked appliance and/or a microserver, which is able to implement the clause as access rules and can make the access control decision without violating the access policy 104 and the policy document. By way of another example, the access control computing system 110 may determine the capabilities of the access control equipment and comparing the access rules 106 to access policy 104 in order to determine that access policy 104 cannot be implemented in the access rules 106 with the existing access control equipment 120 and then may propose an upgrade. The access control computing system 110 may transmit a notification of the possible upgrade to the computing device 160 for notifying a user.

In some embodiments, the door controller 122 or other networked appliance may be configured to escalate an access control decision, for example, when existing hardware of the access control equipment 120 cannot implement a particular policy. For example, the door controller 122 may not be able to implement a two-person escort rule, such as visitor escort rule that requires a visitor to be accompanied by an authorized user. Accordingly, the door controller 122 may be configured to detect that the access request is from a particular cardholder (e.g., a visitor), transmit the access request to the access control computing system 110 and/or to a networked appliance (e.g., Synergis™ Cloud Link hardware appliance provided by Genetec Inc.), which may make the access control decision and then communicate with the door controller 122 to open the door 130 or not based on the access control decision to grant or deny access. In this example, the access control computing system 110 and/or to a networked appliance may check past access events and/or wait for future access events that include the authorized users (e.g., the user that is escorting the visitor). By way of another example, the door controller 122 may only be able to maintain cardholder information of a certain number of cardholders (e.g., 2000 people) yet the secured premises 102 may include a larger number of cardholders (e.g., 50,000 people), and the access control computing system 110 may set the cardholder information at the door controller 122 to be of the most active certain number of cardholders present at the door or doors associated with the door controller 122, and may cause the door controller 122 to escalate the access control decision of the other cardholders to the networked appliance connected to the door controller 122 and/or to the access control computing system 110 for making the access control decision.

It should be appreciated that implementations described herein may allow for various outcomes. The access control computing system 110 may be able to detect policy violations due to the implemented access rules 106 such that policy violations do not go undetected. The access control computing system 110 may detect one or more misconfigured rules in the access rules 106. The access control computing system 110 may detect inadequacies of the access control equipment 120. The access control computing system 110 may allow for clauses of the access policy 104 to be amended with regional exceptions where policy may be override. For example, regional policy may be stricter or less strict that a central policy. The access control computing system 110 may allow for such amendments to be recorded and tracked such that policy derogations are not invisible.

### Example Environments

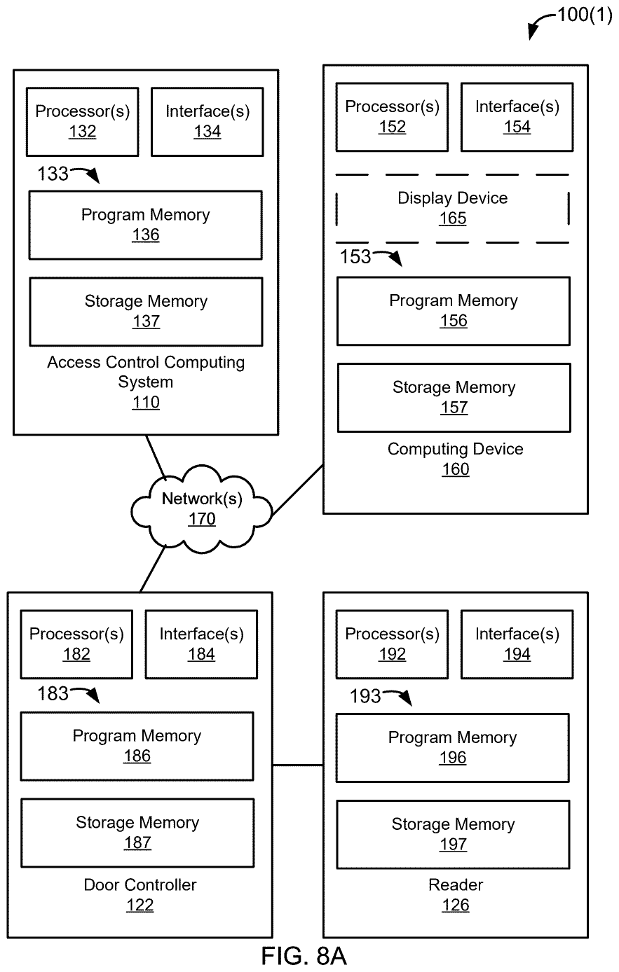

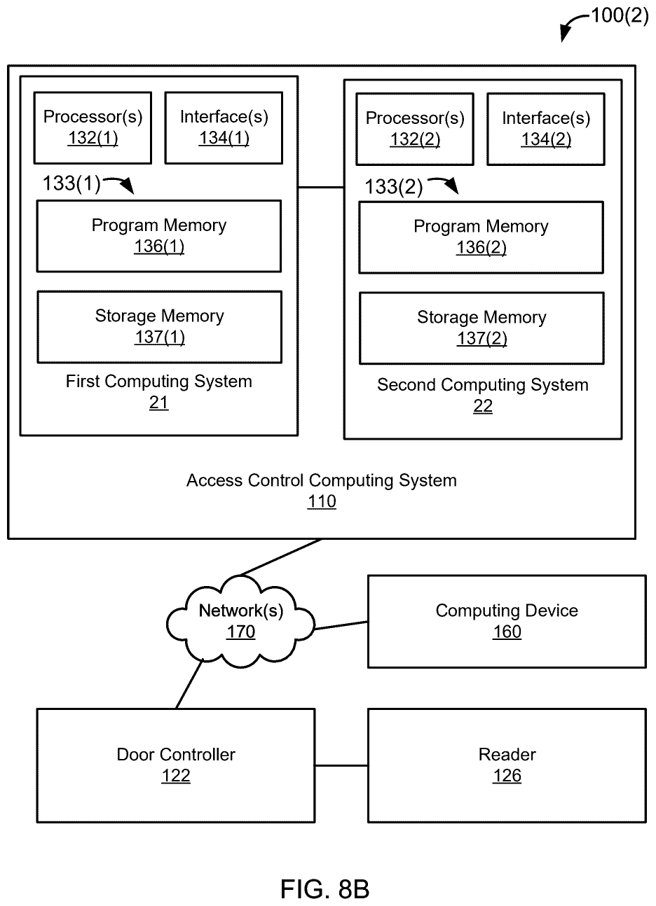

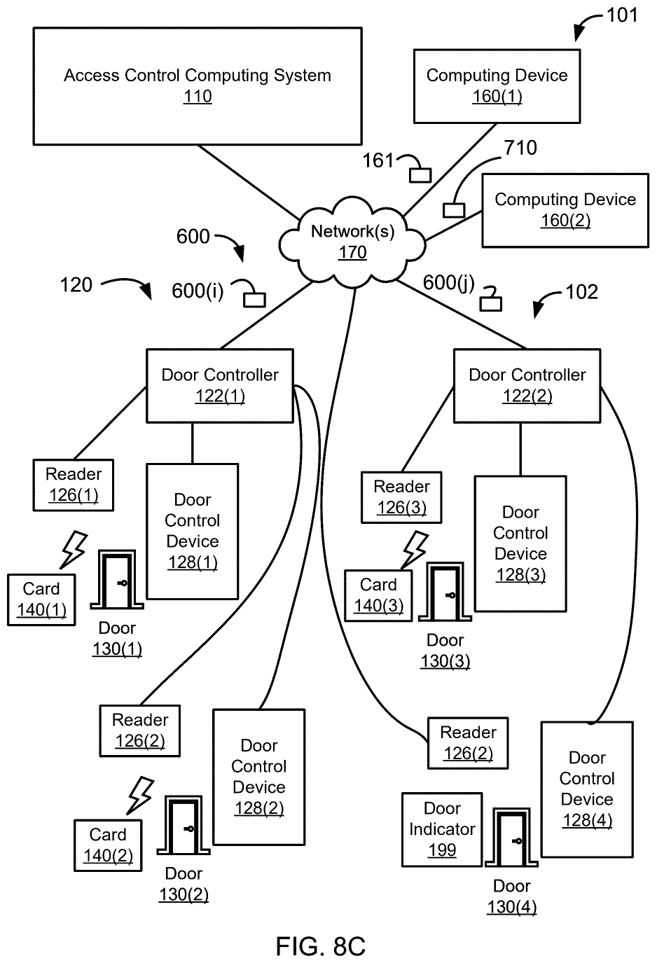

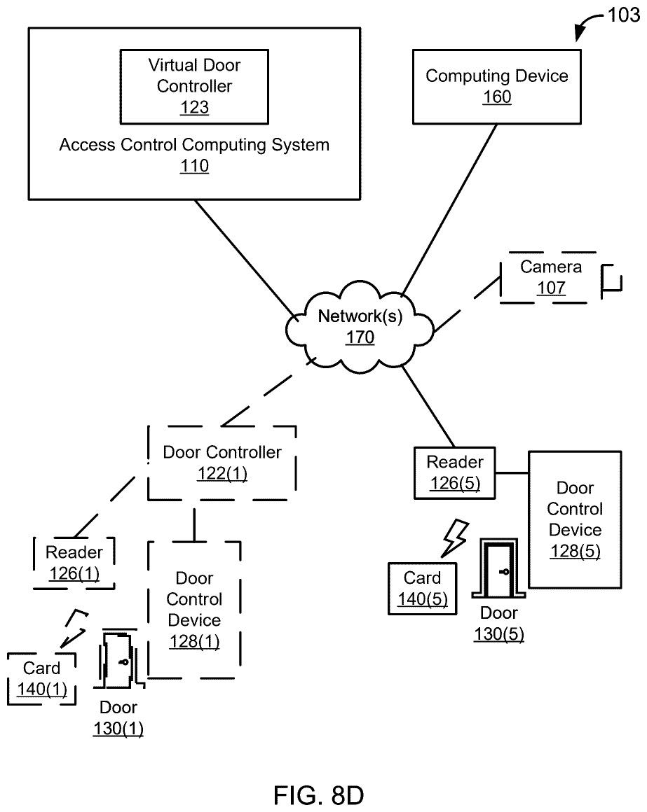

With additional reference to FIG. 8A, example processing circuitry 100(1) of the access control computing system 110, the door controller 122, the reader 126 and the computing device 160 are shown.

In this example, the access control computing system 110 comprise one or more processors 132, and further comprises one or more interfaces 134 and computer readable memory 133 all in communication with the processor(s) 132. The memory 133 has stored thereon program instructions executable by the processor(s) for performing the methods, processes, and/or the various embodiments described herein. The memory 133 may comprise program memory 136. In general, the program memory 136 stores program code that, when executed by the processor(s) 132, cause the processor(s) 132 to implement functions of the access control computing system 110 such as those described herein, for example. The program memory 136 may include operating system program code of an operating system. The memory 133 may comprise storage memory 137. In general, the storage memory 137 stores storage code and/or data. For example, the storage memory 137 may store therein the information stored by the database(s) 114. The storage memory 137 may store therein the access policy 104, the access rules 106, user information 108, premises information 109, schedule information 111, compensatory action information 115, and/or any other suitable information. The storage memory 137 may store therein storage code that is loaded into the program memory to implement the policy validation engine 112, the access manager 118, the policy manager 119, any other program running on the access control computing system 110, and/or any other functions of the access control computing system 110 such as those described herein. The interface(s) 134 may be any suitable input and/or output (I/O) interface(s). The interface(s) 134 may comprise one or more data interfaces and/or one or more network interfaces for communicating with the door controller 122 and/or computing device 160, and/or any other suitable devices. The access control computing system 110 may be connected to various input and/or output devices (e.g., keyboard, mouse, speakers, microphones, etc.) for controlling the access control computing system 110. Accordingly, the access control computing system 110 may be one or more computers, one or more servers, a server cluster, a mainframe, a computing cluster, a cloud computing system, a distributed computing system, a portable computing device, or any other suitable computing device and/or system.

In this example, the computing device 160 comprise one or more processors 152, and further comprises one or more interfaces 154 and computer readable memory 153 all in communication with the processor(s) 152. The memory 153 may comprise program memory 156. In general, the program memory 156 stores program code that, when executed by the processor(s) 152, cause the processor(s) 152 to implement functions of the computing device 160 such as those described herein, for example. The program memory 156 may include operating system program code of an operating system. The memory 153 may comprise storage memory 157. In general, the storage memory 157 stores storage code and/or data. The storage memory 157 may store therein storage code that is loaded into the program memory to implement any computer program running on the computing device 160, for example, the access manager 118 and/or the policy manager 119, and/or any other functions of the computing device 160 such as those described herein. The interface(s) 154 may be any suitable I/O interface(s). The interface(s) 154 may comprise one or more data interfaces and/or one or more network interfaces for communicating with access control computing system 110, the display device 165, and/or any other suitable devices. The computing device 160 may be connected to various input and/or output devices (e.g., keyboard, mouse, speakers, microphones, etc.) for interacting and/or controlling the computing device 160 and/or the access control computing system 110.

In this example, the door controller 122 comprise one or more processors 182, and further comprise one or more interfaces 184 and computer readable memory 183 all in communication with the processor(s) 182. The memory 183 may comprise program memory 186. In general, the program memory 186 stores program code that, when executed by the processor(s) 182, cause the processor(s) 182 to implement functions of the door controller 122 such as those described herein, for example. The memory 183 may comprise storage memory 187. In general, the storage memory 187 stores storage code and/or data. For example, the storage memory 187 may store therein the information stored by the database(s) 124. The storage memory 187 may store therein the access rules 106, the user information 108, and/or any other suitable information. The storage memory 187 may store therein storage code that is loaded into the program memory to implement any computer program running on the door controller 122, and/or any other functions of the door controller 122 such as those described herein. The interface(s) 184 may be any suitable I/O interface(s). The interface(s) 184 may comprise one or more data interfaces and/or one or more network interfaces for communicating with access control computing system 110, the reader 126, and/or any other suitable devices. The door controller 122 may be connected to various input and/or output devices (e.g., keyboard, mouse, speakers, microphones, etc.) for interacting and/or controlling the door controller 122.

In this example, the reader 126 comprise one or more processors 192, and further comprises one or more interfaces 194 and computer readable memory 193 all in communication with the processor(s) 192. The memory 193 may comprise program memory 196. In general, the program memory 196 stores program code that, when executed by the processor(s) 192, cause the processor(s) 192 to implement functions of the reader 126 such as those described herein, for example. The memory 193 may comprise storage memory 197. In general, the storage memory 197 stores storage code and/or data. The storage memory 197 may store therein storage code that is loaded into the program memory to implement any computer program running on the reader 126, and/or any other functions of the reader 126 such as those described herein. The interface(s) 194 may be any suitable I/O interface(s). The interface(s) 194 may comprise one or more data interfaces and/or one or more network interfaces for communicating with the door controller 122, the access control computing system 110, and/or any other suitable devices. The reader 126 may be connected to various input and/or output devices (e.g., pin pads, retina and/or iris scanners, keyboard, mouse, speakers, microphones, near-field communication (NFC) receiver, etc.) for interacting and/or controlling reader 126.

With additional reference to FIG. 8B, another example processing circuitry 100(2) of the access control computing system 110 is shown. In some embodiments, the access control computing system 110 may comprise a first computing system 21 and a second computing system 22. The functionality of the access control computing system 110, as described herein, for example, may be distributed between the first computing system 21 and the second computing system 22. For example, the first computing system 21 may be an on-premises server and the second computing system 22 may be one or more servers implementing cloud computing infrastructure. The first computing system 21 comprise one or more processors 132(1). The first computing system 21 further comprise one or more interfaces 134(1) and computer readable memory 133(1) all in communication with the processor(s) 132(1). The memory 133(1) may comprise program memory 136(1) and storage memory 137(1). The second computing system 22 comprise one or more processors 132(2). The second computing system 22 further comprise one or more interfaces 134(2) and computer readable memory 133(2) all in communication with the processor(s) 132(2). The memory 133(2) may comprise program memory 136(2) and storage memory 137(2). Each processor 132(1), 132(2) may be implemented according to the processor 132 and may function in a same or similar manner to that of the processor 132. Each memory 133(1), 133(2) may be implemented according to the memory 133 and may function in a same or similar manner to that of the memory 133. Each program memory 136(1), 136(2) may be implemented according to the program memory 136 and may function in a same or similar manner to that of the program memory 136. Each storage memory 137(1), 137(2) may be implemented according to the storage memory 137 and may function in a same or similar manner to that of the storage memory 137. Each interface 134(1), 134(2) may be implemented according to the interface 134 and may function in a same or similar manner to that of the interface 134. The first computing system 21 and the second computing system 22 may communicate with each other via their respective interfaces 134(1), 134(2) to implement the functionality of the access control computing system 110, the methods, and/or embodiments described herein, for example.

With reference to FIG. 8C, there is illustrated an example access control system 101 including the access control computing system 110 in communication with access control equipment 120 for controlling access to the secured premises 102. In this example, the access control equipment 120 comprises a plurality of door controllers 122(1), 122(2). Each of door controllers 122(1), 122(2) may be implemented according to the door controller 122 and may function in a same or similar manner to that of the door controller 122. Each door controller 122(1), 122(2) may have a copy of the access rules 106, which may be stored in respective databases of each door controller 122(1), 122(2). Each door controller 122(1), 122(2) may make access control decisions and transmit access events 600, for example, such as access event 600(i) and access event 600(j), to the access control computing system 110. In this example, the door controller 122(1) is connected to a plurality of readers 126(1), 126(2). In this example, the door controller 122(2) is connected to a reader 126(3). Each of reader 126(1), 126(2), 126(3), 126(4) may be implemented according to the reader 126 and may function in a same or similar manner to that of the reader 126. As illustrated, in this example, the readers 126(1), 126(2), 126(3) are contactless card readers that can communicate with a plurality of identification cards 140(1), 140(2), 140(3) presented at any of the readers 126(1), 126(2), 126(3) and retrieves the users' credentials. In some embodiments, the reader 126(4) may be a mobile computing device. The mobile computing device may receive an identifier of the door 130, for example, from a door indicator that may bear or display a visible door identifier, and the mobile computing device transmits an access request to the access control computing system 110. The access request may comprise data representing at least the identifier of the door and an access code. The access control computing system 110 may receive the access request from the mobile computing device, and in response to the request, allows or denies access through the door 130. The doors 130(1), 130(2), 130(3), 130(4) may be at different locations at the secured premise102, for example in a same building or in different buildings of the secured premises 102. Each door 130(1), 130(2), 130(3), may be associated with a corresponding reader 126(1), 126(2), 126(3), and a corresponding door control device 128(1), 128(2), 128(3). The access control computing system 110 may communicate with a plurality of computing devices 160(1), 160(2). Each computing devices 160(1), 160(2) may be implemented according to the computing device 160 and may function in a same or similar manner to that of the computing device 160. By way of an example, a first computing device 160(1) may be used by a first authorized user (e.g., an IT professional) to setup the access rules 106 and/or access policy 104 by transmitting configuration commands 161 to the access control computing system 110, and a second computing device 160(2) may be used by a second authorized user (e.g., a security person) that receives at least one compensatory action item 710. For example, the computing device 160(2) may be used with live monitoring of the secured premises 102 and it could receive the compensatory action item 710 to send security personnel to the access point where a violation of the access policy has occurred.

With reference to FIG. 8D, there is illustrated an example access control system 103 including the access control computing system 110 in communication with access control equipment 120 for controlling access to the secured premises 102. In this example, the access control equipment 120 comprises an IP reader 126(5). The IP reader 126(5) communicates with the access control computing system 110 without communicating through a physical door controller, for example, such as the door controller 122. The IP reader 126(5) may be implemented according to the reader 126 and may function in a same or similar manner to that of the reader 126. The access control computing system 110 may comprise a virtual door controller 123 that implements the functionality of the door controller 122. The virtual door controller 123 may include software running on the access control computing system 110 that makes access control decision, for example, such as those described in relation to the door controller 122. The access control equipment 120 may further comprise a door controller, such as the door controller 122(1), and a reader, such as the reader 126(1). Accordingly, in some embodiments, the at least one door controller 122 of the access control equipment 120 comprises a virtual door controller 123 that implements the functionality of the door controller 122 at the access control computing system 110. Accordingly, in some embodiments, the door controller 122 is optional. One or more reader 126(5) may generate access requests, such as when the card 140(5) is presented at the reader 126(5), which are transmitted to the access control computing system 110. The access control computing system 110 may then process the access requests to make the access control decisions based on the access rules 106 and instructs the door control device 128(5) to unlock the door 130(5) or not. The access control computing system 110 generates the access events, and then compares the access events to the access policy 104 to determine if the access policy 104 is violated by any of the access events.

In some embodiments, the access control equipment 120 may include one or more video cameras 107, such as Internet Protocol (IP) cameras. Each camera 107 may be configured to images and generating video comprising a plurality of image frames in an encoding format (e.g., H.265, H.264, MPEG, or any other suitable encoding format). The camera 107 may be configured to perform video analytics and may generate access events. In some embodiments, the access control computing system 110 may perform the video analytics and generate access event. In some embodiments, another suitable computing system and/or device is configured to perform video analytics and to generate the access events. For example, access events may be generated that pertain to counting or identifying persons or detecting entry into restricted areas.

It should be appreciated that the access control systems 100, 101, and 103, and the various systems and/or devices included therein, may vary from the examples provided, and may vary depending on practical implementations.

### Method

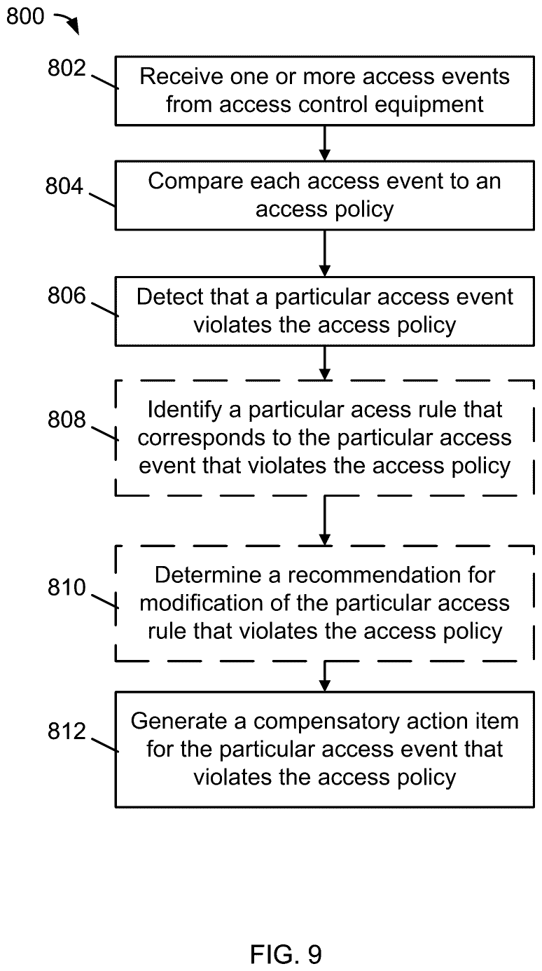

With reference to FIG. 9, there is shown a flowchart illustrating an example method 800. The method 800 may be performed by the access control system 100, 101, and/or 103. The method 800 may be performed by the access control computing system 110, or by any other suitable computing device, system, or the like. In explanation of the method 800, any reference to the systems 100, 101 and 103 is made for example purposes, and the system in which the method 800 may operate may vary depending on practical implementations.

At step 802, one or more access events 600 are received. The access events 600 may be received at the access control computing system 110 from the access control equipment 120 controlling access to the secured premises 102. The access control equipment 120 may include at least one door controller 122, and one or more readers 126 in communication with the at least one door controller 122. The at least one door controller 122 may be configured to receive requests from one or more readers 126 and to control access to the secured premises 102 based on a plurality of access rules 106 for the secured premises 102. The at least one door controller 122 may generate the access events 600 based on the requests from the one or more readers 126. In some embodiments, the access control equipment 120 includes at least one door controller 122(1) in communication with and a plurality of readers 126(1), 126(2), and the door controller 122(1) receives request from the plurality of readers 126(1), 126(2). In some embodiments, the access control equipment 120 includes a plurality of door controller 122(1), 122(2) and each door controller 122(1), 122(2) is in communication with one or more readers (e.g., readers 126(1), 126(2) in communication with the door controller 122(1) and readers 126(3), 126(4) in communication with the door controller 122(2)).

The access events 600 may be transmitted from the door controller 122 (or from a plurality of door controller 122(1), 122(2)) to the access control computing system 110. Each one of the access events 600 may include data, for example, as shown in any of FIGS. 6A to 6E and described in relation thereof. The access events 600 may include any suitable grouping of data that indicates an event pertaining to access requests of the secured premises 102. In some embodiments, each access event 600 may include a timestamp, a user identifier, an access control decision (e.g., grant or deny), and at least one access point identifier. In some embodiments, each access event 600 may include an indication of the requested operation or action, for example, if the access event is an entry or an exit event. In some embodiments, each access event 600 may include an indication of the space that the user was granted or denied access thereto. In some embodiments, the user identifier is a cardholder identifier. In some embodiments, the user identifier is a credential identifier. The credential identifier may correspond to a cardholder identifier or other user identifier. In some embodiments, the at least one access point identifier comprises one or more of: a door identifier, a reader identifier, and/or a door controller identifier. In some embodiments, each access event 600 may further include an identifier of the access rule used to make the access control decision. In some embodiments, each access event 600 corresponds to access grant decisions, and accordingly, each access control event may include a timestamp, a user identifier, an access control decision, an access point identifier, and optionally, an identifier of the access rule used to make the access control decision. In some embodiments, the access events 600 may be received in different formats and comprises different data, for example, when multiple door controllers of different types, make, and/or model are used. In some embodiments, access events 600 may be received from other access control equipment, for example, such as a video analytics system generating access events based on processing video data. In some embodiments, the access events 600 may be generated at the access control computing system 110 based on data received from the access control equipment 120.

At step 804, each access event 600 is compared to the access policy 104. The access control computing system 110 may compare each access event 600 to the access policy 104. Each access event 600 may be compared to the access policy 104 subsequent to receiving each access event 600. For instance, when a particular access event 600(i) is received at the access control computing system 110 this may trigger processing of the particular access event 600(i) such that it is compared to the access policy 104 comprising a plurality of clauses 704 for the secured premises 102. Comparing each access event 600 to the access policy 104 may comprise comparing each access event 600 to each one or at least some of the clauses 704 of the access policy 104. Comparing a particular access event 600(i) to a particular clause 704(i) may be done to determine if the particular access event 600(i) complies with or is in violation of the particular clause 704(i). Data from the particular access event 600(i) may be processed into a form suitable for comparison to the clauses 704 of the access policy 104. For example, a credential identifier of the access event 600(i) may be used to obtain a user identifier, and the user identifier may be used to obtain one or more user groups that the user corresponding to the user identifier is a part thereof. By way of another example, the user identifier of the access event 600(i) may be used to obtain one or more user groups. By way of yet another example, an access point identifier of the access event 600(i) may be used to identify one or more access points. The user groups and/or access points identified from the access event 600(i) may then be compared to one or more clauses of the access policy 104 to determine if a given clause is applicable or not. For instance, if a given clause does not pertain to the identified access point and/or identified user group(s), it may not be applicable; however, if a given clause does pertain to at least one of the identified access point and the identified user group(s), then it may be applicable. Then, for example, if a given clause is appliable, further data of the access event 600(i) such as the access control decision and/or timestamp may be compared to the given clause to determine if the given clause is met or violated by the access event 600(i).

In some embodiments, each of the clauses 704 includes one or more conditions, and the one or more conditions may include one or more attribute-based expressions, such as, for example, one or more attribute-conditional rules. The comparing of the access events 600 to the access policy 104 at step 804 may include comparing one or more attributes associated with each access event 600 to one or more attribute-based expressions (e.g., one or more attribute-conditional rules). Step 804 may include processing each access event 600 to obtain an attribute set associated with each access event. A particular access event 600(i) may be processed to obtain one or more attributes in the set, including any one or more of the following: one or more subject attributes associated with the user, one or more object attributes associated with the access point and/or the space that the user is requesting access thereto, one or more action attributes associated with the action performed (e.g., entered, exited, etc.) at the access point, and/or one or more environmental attributes at the time of the access event 600(i) and/or access request. A particular access event 600(i) may be processed to generate a set of parameters of the particular access event 600(i) and the set of parameters may be used to obtain attribute set, for example, by querying one or more data sources with one of more parameters of the set of parameters. The obtained attributes in the set may be compared to the one or more attribute-based expressions (e.g., the one or more attribute-conditional rules) to identify a subset of clauses applicable to the particular access event 600(i), for example to identify a subset of clauses applicable to the user (or subject) and/or to identify a subset of clauses applicable to the access point (or object), and/or may be compared to identify if any clause (e.g., in the identified subset or subsets of clauses) is satisfied or violated by the particular access event 600(i).

In some embodiments, comparing each access event 600 to the access policy 104 subsequent to receiving each access event 600 at step 804 occurs in real-time or near real-time. Any processing and/or reception that occurs in “real-time” or “near real-time” can include any transmission delay, system propagation delay, processing delay and/or any other suitable delay.

In some embodiments, comparing each access event 600 to the access policy 104 subsequent to receiving each access event 600 at step 804 occurs at a scheduled time. For example, multiple access events 600 may be compared in a batch at a scheduled time. The scheduled time may be set at one or more points in time, for example, such as one or more points in time in a day, week, or month. The scheduled time may be an interval of time, for example, such as every 60 seconds, every hour, or every day. In some embodiments, the scheduled time is a period of no longer than 60 seconds. In some embodiments, the scheduled time is less than 1 hour. In some embodiments, the schedule time is less than 1 day.

At step 806, a particular access event 600(i) is detected to violate the access policy 104. Step 806 may occur when the particular access 600(i) event is compared to the access policy 104 at step 804 and the particular access event 600(i) violates a particular clause 704(i). In other words, when the particular access event 600(i) violates at least one particular clause 704(i) of the access policy 104, it may be said that the particular access event 600(i) violates the access policy 104. In some embodiments, the particular access event 600(i) violates multiple clauses of the access policy 104. The particular access event 600(i) may be detected to violate the access policy 104 when the access control decision of the particular access event 600(i) is contrary to a particular clause 704(i) of the access policy 104 at a time corresponding to the timestamp of the particular access event 600(i) for a user corresponding to the user identifier of the particular access event 600(i) at an access point corresponding to the access point identifier of the particular access event 600(i). For example, the particular access event 600(i) may be contrary to the particular clause 704(i) when the particular access event 600(i) grants access and the particular clause 704(i) would deny access, or vice versa.

In some embodiments, detecting that the particular access event 600(i) violates the access policy 104 at step 806 includes detecting that access policy 104 excludes (i.e., does not include) any clause for providing a same decision to that of the access control decision of the particular access event 600(i). For example, the particular access event 600(i) may grant access to a particular user to a particular space, yet the access policy 104 does not include any clause that would allow the particular user access to the particular space.

In some embodiments, detecting that the particular access event 600(i) violates the access policy 104 at step 806 includes evaluating the at least one condition of each clause of the access policy 104, or of a subset of applicable clauses of the access policy 104, and determining that each of the at least one condition of each clause in the access policy, or in the subset of applicable clauses, does not apply to the particular access event 600(i) or evaluates to a logical false (i.e., is not satisfied). In other words, none of the conditions of the clauses in the access policy, or in the subset of applicable clauses, evaluate to a logical true (i.e., is satisfied). For example, the particular access event 600(i) may grant access to a particular user to a particular space, yet the clauses of the access policy 104, or a subset of clauses that pertain to the particular space and/or that pertain to particular user, each include a condition (e.g., an attribute-conditional rule) that evaluates to not being satisfied (e.g., logical false) based on the particular access event 600(i). The condition may evaluate to not being satisfied when the parameters of the particular access event 600(i), and/or the obtained attributes associated with the particular access event 600(i), when compared to the condition evaluate to a logical false.

In some embodiments, detecting that the particular access event 600(i) violates the access policy 104 as step 806 includes detecting that the particular access event 600(i) violates the access policy 104 when the at least one attribute-conditional rule of at least one particular clause is violated. For example, the identified subset of clauses applicable to the user (or subject) and/or applicable to the access point (or object), may be evaluated by evaluating each attribute-conditional rule to determine if any of the attribute-conditional rules are satisfied and/or if all of the attribute-conditional rules in the subset are violated.

In some embodiments, the clauses 704 of the access policy 104 comprises a particular clause 704(i) that is incompatible with the access control equipment 120 such that the particular clause 704(i) is unsuitable to be implemented as a corresponding rule in the access rules 106. Accordingly, in some embodiments, detecting that the particular access 600(i) event violates the access policy 104 at step 806 comprises detecting that the particular access event 600(i) violates the particular clause 704(i) that is unsuitable to be implemented as a corresponding rule in the access rules 106. In some embodiments, the method 800 may include determining that a particular access control device (e.g., a networked appliance and/or microserver etc.) may be added into the access control equipment 120 as it would be suitable to implement the rule corresponding to the particular clause 704(i) that is unsuitable to be implemented as a corresponding rule in the access rules 106 with the existing access control equipment 120. A notification recommending the particular access control device may be transmitted to the computing device 160 to notify a user of the possible upgrade to the access control equipment 120 in order to implement the rule.

The method 800 optionally includes step 808. At step 808, a particular access rule 706(i) is identified that corresponds to the particular access event 600(i) that violates the access policy 104. In some embodiments, step 808 includes emulating access at an access point corresponding to the particular access event 600(i) to detect the particular access rule 706(i). In some embodiments, step 808 includes obtaining the particular access rule 706(i) from a plurality of access rules 706 using an identifier of the access rule obtained from the particular access event 600(i).

The method 800 optionally includes step 810. At step 810, the particular access rule 706(i) identified at step 808 is compared to the at least one particular clause 704(i) that is violated by the particular access event 600(i) to determine a recommendation for user modification of the particular access rule 706(i). The recommendation for user modification may be based on a difference between the particular access rule 706(i) and the particular clause 704(i) that is violated by the particular access event 600(i). The particular access rule 706(i) once identified may be compared to the particular clause 704(i) that is violated by the particular access event 600(i) to determine the difference between the particular access rule 706(i) and the particular clause 704(i) that is violated by the particular access event 600(i). The difference may then be included in the compensatory action 710 to form the recommendation for the user modification of the particular access rule 706(i). The recommended may be to change a parameter, such as one of the conditions and/or fields, of the particular access rule 706(i) from a current value to a new value corresponding to that of the access clause 704(i) for that parameter based on the identified difference. A notification recommending the modification of the particular access rule 706(i) may be transmitted to the computing device 160 to notify a user of the recommended modification.

At step 812, a compensatory action item 710 is generated for the particular access event 600(i) that violates the access policy 104. The compensatory action item 710 is an action item for a compensatory action to be taken. The compensatory action item 710 may be generated at the access control computing system 110. The compensatory action item 710 may be transmitted by the access control computing system 110 to the computing device 160 (or the computing device 160(2)) over the network(s) 170. Accordingly, in some embodiments, generating the compensatory action item 710 comprises transmitting an alert to the computing device 160 in communication with the access control computing system 110 to notify a user of the computing device 160 to take a compensatory action. The compensatory action item 710 may be stored by the access control computing system 110 in the database(s) 114 such that it may be retrieved at a later time.

The access policy 104 may indicate for each clause of the plurality of clauses 704 a corresponding compensatory action that is to be performed, for example, as shown in FIGS. 3A and 3B. Accordingly, in some embodiments, each clause 704 in the access policy 104 has a compensatory action associated therewith, and when generating the compensatory action item 710 this may be based on the compensatory action of the at least one particular clause 704(i) that is violated by the particular access event 600(i).

The access policy 104 may indicate for each clause 704 of the plurality of clauses 704 a corresponding security threat level applies. Each clause could have a corresponding security threat level, and different security threat levels may have different compensatory actions associated therewith. The compensatory action item 710 may be generated based on the security threat level of the at least one particular clause 704(i) that is violated by the particular access event 600(i). The security threat level may be obtained from the of the at least one particular clause 704(i) that is violated by the particular access event 600 and used to generate the compensatory action corresponding to the obtained security threat level.

In some embodiments, the compensatory action item 710 may include a request to modify the particular access rule 706(i) identified at step 808. Accordingly, the compensatory action item 710 may comprise a request for user modification of the particular access rule 706(i) that resulted in the access control decision of the particular access event 606ᵢ that violates the access policy 104. In some embodiments, the compensatory action item 710 may comprise the recommendation for the user modification of the particular access rule 706(i) of step 810.

In some embodiments, the compensatory action item 710 comprises a notification to send security personnel to an access point associated with the particular access event 600(i). The access point identifier may be obtained from the particular access event 600(i) and used to identify which access point to direct security personnel thereto.

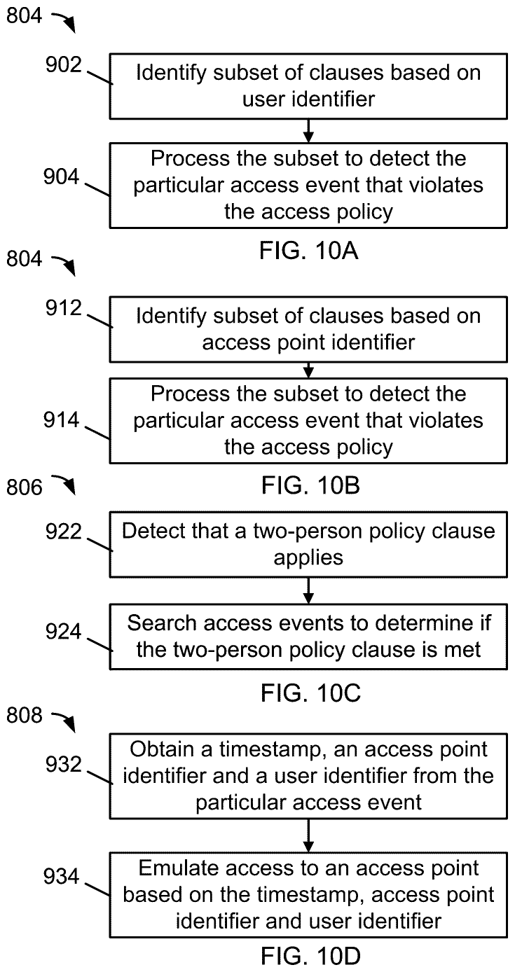

With reference to FIGS. 10A and 10B, in some embodiments, step 804 may include identifying a subset of clauses that are applicable for a particular access event 600(i) and comparing the particular access event 600(i) to the subset. A subset of clauses refers to one or more clauses. The subset could be identified based on the user identifier and/or the access point identifier obtained from the particular access event 600(i). For example, from the user identifier it can be determined that the user is an employee and only clauses that apply to employees need to be applied (i.e., visitor clauses can be omitted). By way of another example, the access point could be a server room door, and only access clauses that apply to server room doors need to be applied. With additional reference to FIG. 10A, in some embodiments, step 804 includes: at step 902, identifying a subset of clauses of the access policy 104 based on the user identifier of each access event 600 and, at step 904, processing the subset of clauses to detect that the particular access event 600(i) violates the access policy 104. With additional reference to FIG. 10B, in some embodiments, step 804 includes, at step 912, identifying a subset of clauses of the access policy 104 based on the access point identifier of each access event 600 and, at step 914, processing the subset of clauses to detect that the particular access event 600(i) violates the access policy.

With additional reference to FIG. 10C, in some embodiments, step 804 may include, at step 922, detecting a two-person policy clause, such as visitor escort policy clause, applies, and, at step 924, searching the access events for another access event that results in the two-person policy clause being met or not. In some embodiments, step 922 comprises detecting for the particular access event 600(i) that a two-person policy clause applies to at least one of a user and an access point corresponding to the particular access event 600(i). In some embodiments, step 806 comprises determining failure of the two-person policy clause based on absence of another access events occurring within a timeframe surrounding the particular access event 600(i). In some embodiments, the two-person policy clause is a visitor escort policy clause indicating that the user associated with the particular access event 600(i) must be escorted by an authorized user for the access point associated with the particular access event.

With additional reference to FIG. 10D, in some embodiments, step 808 may be performed, for example, when the compensatory action item 710 is a request for a user to modify the particular access rule 706(i). In some embodiments, step 808 comprises, at step 932, obtaining a timestamp, an access point identifier and a user identifier from the particular access event 600(i), and, at step 934, emulating access to an access point corresponding to the access point identifier 614 of the particular access event 600(i) with the user identifier of the particular access event 600(i) at a time corresponding to the timestamp of the particular access event 600(i), thereby identifying the particular access rule 706(i).

In some embodiments, where the access control computing system 110 implements the door controller 122 functionality, for example, with the virtual door controller 123, the access control computing system 110 generates the access events 600 that are obtained at the access control computing system 110 at step 802.

The order of the steps 802, 804, 806, 808, 810, and 812 of the method 800 may vary depending on practical implementations and when suitable to change the order. Similarly, when suitable, the various steps of the method 800 described herein may be combined, uncombined, and/or omitted. For example, step 812 may occur before step 808.

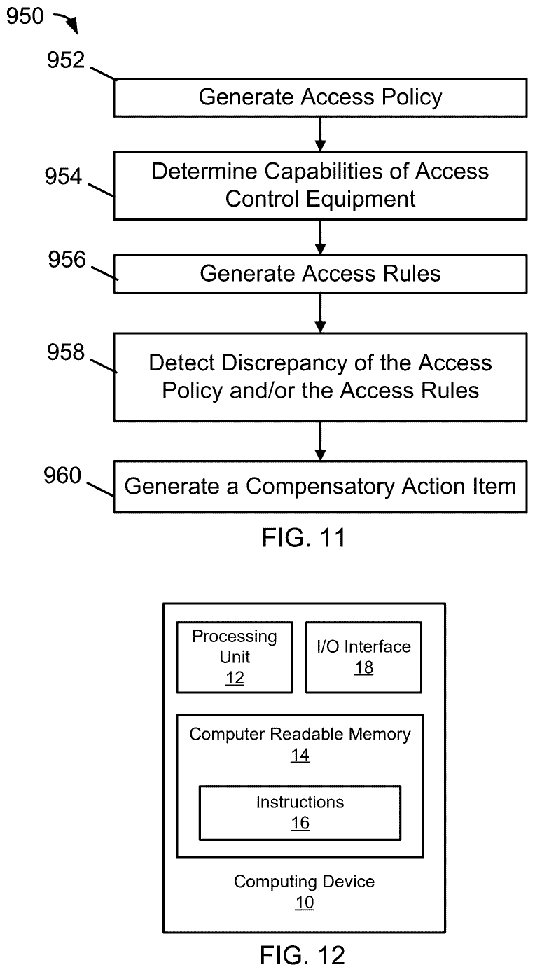

With reference to FIG. 11, there is shown a flowchart illustrating an example method 950. The method 950 may be performed by the access control system 100, 101, and/or 103. The method 950 may be performed by the access control computing system 110, or by any other suitable computing device, system, or the like. In explanation of the method 950, any reference to the systems 100, 101 and 103 is made for example purposes, and the system in which the method 950 may operate may vary depending on practical implementations.

Step 952 includes, in some embodiments, generating an access policy 104. The access policy 104 may be generated from a human language policy document based on user input. The user may cause the access control computing system 110 to generate the access policy 104 based on user input via GUI, for example as shown in any of FIGS. 2A to 2G. The access policy 104 may be generated based on processing the human language policy document with a language model (e.g., a large language model). The language model may generate proposed clauses for the access policy 104 which may be reviewed, edited and/or approved by the user to create the clauses in the access policy 104.

Step 954 includes, in some embodiments, determining a set of capabilities of the access control equipment 120. The capabilities of the access control equipment 120 may include processing, storing, transmission, and/or performing functions capabilities. The capabilities of the access control equipment 120 may include capabilities of the door controller 122. The capabilities of the door controller 122 may include an access control functioning capabilities and/or model (e.g., IBAC, ACL, RBAC, etc.) of the door controller 122, the maximum number of cardholders that the door controller 122 can store user information and/or credential information thereon, if the door controller 122 is capable of implementing a two-person rule (e.g., visitor escort rule) or any other suitable capabilities. An equipment description language may describe the capabilities of the access control equipment 120, which may be accessed to determine the capabilities of the access control equipment 120. The equipment description language may include specifications of the processing, storing, transmission, and/or performing functions capabilities of each of devices and/or systems (e.g., the door controller 122, the reader 126, the door control device 128, the access control computing system 110, etc.) in the access control equipment and/or the access control system 100, 101 and/or 103.

Step 956 includes, in some embodiments, generating access rules 106. The access rules 106 may be generated from the human language policy document or the access policy 104. The user may cause the access control computing system 110 to generate the access rules 106 based on user input via GUI, for example as shown in FIGS. 4A and 4B. The access rules 106 may be generated based on processing the human language policy document with a language model (e.g., a large language model). The language model may generate proposed rules for the access rules 106 which may be reviewed, edited and/or approved by the user to create the rules in the access rules 106. In some embodiments, the access rules 106 are generated from the access policy 104 based on the capabilities of the access control equipment 120 (e.g., the capabilities of the door controller 122). There may be one or more mapping rules that specify how to map the clauses of the access policy 104 to the capabilities of the access control equipment 120 (e.g., the capabilities of the door controller 122) in order to generate the rules of the access rules 106. The mapping may include converting the access policy 104 specified in a first hardware-based language (e.g., XACML or based on ABAC) into a second hardware-based language (e.g., to be specified based on IBAC or RBAC). The mapping rules may include mapping rules for converting the first hardware-based language used to specify the access policy 104 into the second hardware-based language based on the capabilities of access control equipment 120 implementing the access rules 106 specified in the second hardware-based language.

Step 958 includes, in some embodiments, detecting at least one discrepancy. Step 958 may include detecting at least one discrepancy between the access policy 104 and the access rules 106. In some embodiments, the access policy 104 may be compared to the access rules 106 to detect the discrepancy. In some embodiments, when the access rules 106 are generated from the access policy 104 based on the capabilities of the access control equipment 120, the discrepancy may be detected. This may include detecting that the mapping is not possible (i.e., impossible) without a discrepancy between the access policy 104 and the access rules 106. The discrepancy may include detecting that the access policy 104 comprises a clause that cannot be implemented in a rule of the access rules 104, for example, due to the fact that the clause is too complex to be implemented by the access control equipment 120 (e.g., the door controller 122) and/or the access control equipment 120 (e.g., the door controller 122) lacks the capability to implement the clause as a rule.

Step 958 may include detecting at least one discrepancy in the access rules 106 and/or in the access policy 104. In some embodiments, step 958 may include detecting at least one discrepancy in the access policy 104 based on comparing the clauses of the access policy 104 to each other. The clauses of the access policy 104 may be compared to each other to determine if there is a contradiction between two or more clauses. In some embodiments, step 958 may include detecting at least one discrepancy in the access rules 106 based on comparing the rules of the access rules 106 to each other. The access rules 106 may be compared to each other to determine if there is a contradiction between two or more rules. Accordingly, the at least one discrepancy may include at least one contradiction between two or more clauses and/or two or more rules.

Step 960 includes, in some embodiment, generating a compensatory action item. The compensatory action item may be generated in response to the detecting of the discrepancy at step 958. The compensatory action item, for example, may be a described at step 812 of the method 800 or as elsewhere described in this document. The compensatory action item may include a notification to indicate that the mapping is impossible and/or to indicate the discrepancy. The compensatory action item may include proposing a hardware upgrade that a particular access control device be added into the access control equipment 120. The hardware upgrade may be to replace an existing access control device (e.g., a door controller) with the particular access control device (e.g., a different door controller). The hardware upgrade may be to connect the particular access control device (e.g., a networked appliance and/or microserver) to an existing access control device (e.g., a door controller). The compensatory action item may include instructions for configuring the access control equipment 120 (e.g., a door controller) such that the access control decisions that at least pertain to the discrepancy (e.g., the clause that cannot be implemented as rule) be escalated to hardware capable of implementing the clause as a rule (e.g., to a networked appliance, microserver and/or the access control computing system 110). For example, this may include configuring the door controller 122 such that any access requests from cardholders appliable to a two-person rule (e.g., visitor, which are applicable to a visitor escort rule) are transmitted to an access control device (e.g., to a networked appliance, microserver and/or the access control computing system 110) capable of implementing the two-person rule.

The order of the steps 952, 954, 956, 958 and 960 of the method 950 may vary depending on practical implementations and when suitable to change the order. Similarly, when suitable, the various steps of the method 950 described herein may be combined, uncombined, and/or omitted. Any of the embodiments, examples, implementations, features and/or functionality described in relation to the systems 100, 101 and/or 103 may be incorporated into the methods 800 and/or 950. The methods 800 and 950 may be combined and any of the steps of the methods 800 and 950 may be combined into a common method, where appropriate to do so.

### Computing Device

With reference to FIG. 12, the method 800 and/or method 950 may be implemented by one or more computing devices, such as a computing device 10 comprising a processing unit 12 and a memory 14 which has stored therein computer-executable instructions 16. Each of the access control computing system 110, the computing device 160, 160(1), 160(2), the door controller 122, 122(1), 122(2), the networked appliance, the microserver, reader 126, 126(1), 126(2), 126(3), 126(4), 126(5), and/or any other access control device, may each be implemented by and/or comprise at least one computing device, such as the computing device 10.

The processing unit 12 may comprise any suitable devices configured to implement the method 800 and/or method 950 such that instructions 16, when executed by the computing device 10 or other programmable apparatus, may cause the functions/acts/steps performed as part of the method 800 and/or method 950 as described herein to be executed. The processing unit 12 may comprise, for example, one or more of: any type of general-purpose microprocessor or microcontroller, a digital signal processing (DSP) processor, a central processing unit (CPU), a graphical processing unit (GPU), a neural processing unit (NPU), an integrated circuit, a field programmable gate array (FPGA), a reconfigurable processor, other suitably programmed or programmable logic circuits, or any combination thereof. The processing unit 12 may be referred to as a “processor”. Any of the processors 132, 132(1), 132(2), 152, 182, 192, may each be implemented by and/or comprise one or more of the processing unit 12.

The memory 14 may comprise any suitable known or other machine-readable storage medium. The memory 14 may comprise non-transitory computer readable storage medium, for example, but not limited to, an electronic, magnetic, optical, electromagnetic, infrared, or semiconductor system, apparatus, or device, or any suitable combination of the foregoing. The memory 14 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 14 may comprise any storage means (e.g., devices) suitable for retrievably storing machine-readable instructions 16 executable by processing unit 12. The memory 14 may include any suitable hard drives, memory cards, Secure Digital (SD) cards or the like. The memory of the database(s) 114 and/or 124 may be implemented according to the memory 14, and may comprise any suitable known or other machine-readable storage medium. Any of the memory 136, 136(1), 136(2), 137, 137(1), 137(2), 156, 157, 186, 187, 196, 197 may each be implemented by and/or comprise one or more of the memory 14.

The I/O interface 18 may include various signal interfaces, analog-to-digital converters (ADCs), digital-to-analog converters (DACs), receivers, transmitters, and/or other circuitry to receive, produce, and transmit signals as described herein, for example. The I/O interface 18 may include a network interface operable to transmit signals to, and receive signals from, a computer network (for example, using a wireless-network access point, or a wired or other wireless connection to a router). The I/O interface 18 may include a near-field communication (NFC) input/output interface 18 operable to transmit NFC radio signals to, and receive NFC radio signals from, a nearby NFC device, a Bluetooth™ input/output interface operable to transmit Bluetooth™ radio signals to, and receive radio Bluetooth™ signals from, a nearby Bluetooth™ device, and an output interface operable to transmit signals to a display device to control a screen and/or user interface on the display device. Any of the interfaces 134, 134(1), 134(2), 154, 184, 194, may each be implemented by and/or comprise one or more of the I/O interface 18.

The methods and systems described herein may be implemented in a high level procedural or object oriented programming or scripting language, or a combination thereof, to communicate with or assist in the operation of a computer system, for example the computing device 10. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or in some embodiments the processing unit 12 of the computing device 10, to operate in a specific and predefined manner to perform the functions described herein. Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure. Various aspects of the methods and systems described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. A method performed by an access control computing system, the method comprising:
receiving access events from access control equipment controlling access to a secured premises, the access control equipment includes a door controller and one or more readers in communication with the door controller, the door controller configured to receive requests from the one or more readers and to control access to the secured premises based on a plurality of access rules for the secured premises, the door controller generating the access events based on the requests from the one or more readers;
comparing each access event of the access events to an access policy subsequent to receiving each access event, the access policy comprising a plurality of clauses for the secured premise, and detecting that a particular access event of the access events violates at least one clause of the access policy; and
generating a compensatory action item for the particular access event that violates the access policy.

2. The method of claim 1, wherein each access event comprises a timestamp, a user identifier, an access control decision and an access point identifier.

3. The method of claim 2, wherein the method further comprises:
identifying a particular access rule of the plurality of access rules that resulted in the access control decision of the particular access event that violates the access policy.

4. The method of claim 3, wherein the compensatory action item comprises a request for user modification of the particular access rule that resulted in the access control decision of the particular access event that violates the access policy.

5. The method of claim 4, wherein the method further comprises:
comparing the particular access rule to the at least one clause of the access policy that is violated by the particular access event to determine a recommendation for the user modification of the particular access rule based on a difference between the particular access rule and the at least one clause that is violated by the particular access event, and
wherein the compensatory action item comprises the recommendation for the user modification of the particular access rule.

6. The method of claim 3, wherein identifying the particular access rule comprises emulating access to an access point corresponding to the access point identifier with the user identifier of the particular access event at a time corresponding to the timestamp of the particular access event.

7. The method of claim 3, wherein each access event further comprises an identifier of an access rule corresponding to the access control decision, and wherein identifying the particular access rule comprises obtaining the particular access rule from the plurality of access rules using the identifier of the access rule.

8. The method of claim 1, wherein generating the compensatory action item comprises:
transmitting an alert to a computing device in communication with the access control computing system to notify a user of the computing device to take a compensatory action.

9. The method of claim 8, wherein the compensatory action item comprises a notification to send security personnel to an access point associated with the particular access event.

10. The method of claim 1, wherein the plurality of clauses of the access policy comprises a two-person policy clause, and wherein said detecting that the particular access event violates the access policy comprises:
detecting for the particular access event that the two-person policy clause of the access policy applies to at least one of a user and an access point corresponding to the particular access event; and
determining failure of the two-person policy clause based on an absence of another access events occurring within a timeframe surrounding the particular access event.

11. The method of claim 10, wherein the two-person policy clause is a visitor escort policy clause indicating that the user associated with the particular access event must be escorted by an authorized user for the access point associated with the particular access event.

12. The method of claim 1, wherein each clause in the access policy has a compensatory action associated therewith; and wherein said generating the compensatory action item is based on the compensatory action of the at least one clause violated by the particular access event.

13. The method of claim 2, wherein said comparing comprises:
identifying a subset of clauses of the plurality of clauses of the access policy based on the user identifier of the particular access event; and
processing the subset of clauses to detect the particular access event that violates the access policy.

14. The method of claim 2, wherein said comparing comprises:
identifying a subset of clauses of the plurality of clauses of the access policy based on the access point identifier of the particular access event; and
processing the subset of clauses to detect the particular access event that violates the access policy.

15. The method of claim 1, wherein said comparing each access event to the access policy subsequent to receiving each access event occurs in real-time or near real-time.

16. The method of claim 1, wherein said comparing each access event to the access policy subsequent to receiving each access event occurs at a scheduled time.

17. The method of claim 1, wherein the plurality of clauses of the access policy comprises a particular clause that is incompatible with the access control equipment such that the particular clause is unsuitable to be implemented as a corresponding rule in the plurality of access rules.

18. The method of claim 17, wherein detecting that the particular access event violates the access policy comprises detecting that the particular access event violates the particular clause that is unsuitable to be implemented as a corresponding rule in the plurality of access rules.

19. A computing system comprising:
at least one processor; and
at least one non-transitory computer-readable memory having stored thereon program instructions executable by the at least one processor for:
receiving access events from access control equipment controlling access to a secured premises, the access control equipment includes a door controller and one or more readers in communication with the door controller, the door controller configured to receive requests from the one or more readers and to control access to the secured premises based on a plurality of access rules for the secured premises, the door controller generating the access events based on the requests from the one or more readers;
comparing each access event of the access events to an access policy subsequent to receiving each access event, the access policy comprising a plurality of clauses for the secured premise, and detecting that a particular access event of the access events violates at least one clause of the access policy; and
generating a compensatory action item for the particular access event that violates the access policy.

20. A non-transitory computer-readable storage medium having stored thereon program instructions which, when executed, cause at least one processor to:
receive access events from access control equipment controlling access to a secured premises, the access control equipment includes a door controller and one or more readers in communication with the door controller, the door controller configured to receive requests from the one or more readers and to control access to the secured premises based on a plurality of access rules for the secured premises, the door controller generating the access events based on the requests from the one or more readers;
compare each access event of the access events to an access policy subsequent to receiving each access event, the access policy comprising a plurality of clauses for the secured premise, and detect that a particular access event of the access events violates at least one clause of the access policy; and
generate a compensatory action item for the particular access event that violates the access policy.
